(19) United States
(12) Patent Application Publication
(10) Pub. No.: US 2016/0014586 A1
(43) Pub. Date: Jan. 14, 2016

(54) VEHICULAR SMALL CELL DATA TRANSPORT AND EMERGENCY SERVICES

(71) Applicant: QUALCOMM Incorporated, San Diego, CA (US)

(72) Inventors: Patrick STUPAR, Nuremberg (DE); Stephen William EDGE, Escondido, CA (US); Sven FISCHER, Nuremberg (DE); Andrea GARAVAGLIA, Nuremberg (DE); Rajat PRAKASH, San Diego, CA (US); Yeliz TOKGOZ, San Diego, CA (US); Kalle Ilmari AHMAVAARA, San Diego, CA (US)

(21) Appl. No.: 14/796,442

(22) Filed: Jul. 10, 2015

Related U.S. Application Data
(60) Provisional application No. 62/023,612, filed on Jul. 11, 2014.
(60) Provisional application No. 62/035,974, filed on Aug. 11, 2014.

(51) Int. Cl. H04W 4/22; H04L 29/08; H04W 16/32; H04W 4/04

(52) U.S. Cl. CPC H04W 4/22; H04W 4/046; H04L 67/12; H04W 16/32; H04W 84/12

(57) ABSTRACT

Aspects of using a small cell deployed in a vehicle are provided. For example, identifying the location of a wireless device includes enabling communication with a positioning server (e.g., enhanced serving mobile location center (E-SMLC)) in a home network using a positioning protocol, wherein the communication is enabled using a wireless backhaul connection to a serving network, receiving a location request from the positioning server for the location of the wireless device connected to the small cell and associated with an emergency call, determining location information for the wireless device, and providing, to the positioning server through the communication, the location information. The wireless backhaul connection to the serving network may be based on a wireless local area network (WLAN) connection.

### CLAIM OF PRIORITY

The present application for Patent claims priority to Provisional Application No. 62/023,612 entitled “Vehicular Small Cell Data Transport and Emergency Call” filed Jul. 11, 2014, and to Provisional Application No. 62/035,974 entitled “Vehicular Small Cell Data Transport and Emergency Call” filed Aug. 11, 2014, which are assigned to the assignee hereof and hereby expressly incorporated by reference herein.

### BACKGROUND

Aspects of the present disclosure relate generally to wireless communications systems, and more particularly to small cells and the like.

Wireless communications networks are widely deployed to provide various communication services such as telephony, video, data, messaging, broadcast, and so on. Such networks, which are usually multiple access networks, support communications for multiple users by sharing the available network resources. In cellular networks, macro base stations (or macro cells or conventional base stations) provide connectivity and coverage to a large number of users over a certain geographical area that may typically range from a few hundred meters across (e.g. in an urban area) to a few tens of kilometers across (e.g. in a rural area). To supplement macro base stations, restricted power or restricted coverage base stations, referred to as small coverage base stations, small cell base stations, femtocells or small cells, can be deployed to provide more robust wireless coverage and capacity to mobile devices. As used herein, the term “small cell” may refer to an access point or to a corresponding coverage area of the access point, where the access point in this case has a relatively low transmit power or relatively small coverage as compared to, for example, the transmit power or coverage area of a macro network base station or macro cell. Therefore, the term “small cell,” as used herein, refers to a relatively low transmit power and/or a relatively small coverage area cell as compared to a macro cell.

The deployment of small cell base stations may provide incremental capacity growth, richer user experience, in-building or other specific geographic coverage, and so on. While small cells may most typically be deployed at fixed locations such as in outdoor dense urban environments or inside buildings, deployment of small cells at mobile locations such as inside vehicles, trains, ships or airplanes may also be considered as a means to extend network wireless coverage to a greater number of users. However, deployment of small cells at mobile locations may introduce new challenges for providing certain services such as emergency calls that are traditionally only offered to users accessing macrocells and small cells at fixed locations. For example, one challenge may be to ensure that an emergency call is routed to the correct local PSAP supporting emergency calls at the location of a mobile small cell even though the mobile small cell may have no permanent association with any one PSAP. Another challenge may be to ensure that the PSAP is able to locate the user who is accessing the mobile small cell even though the location of the mobile small cell may be frequently changing.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents various examples of methods, apparatus, devices, and systems for Vehicular Small Cell (VSC) data transport and emergency calls.

In one aspect, a method at a small cell deployed in a vehicle for transporting data on behalf of a first wireless device is described in which a first device bearer corresponding to a link from the first wireless device through the small cell to a home network is identified, a first network bearer corresponding to a link from the small cell to a serving network is identified, and the first device bearer is mapped to the first network bearer to transport data between the first wireless device and the home network.

In another aspect, an apparatus at a small cell deployed in a vehicle for transporting data on behalf of a first wireless device is described that includes a first identifier component configured to identify a first device bearer corresponding to a link from the first wireless device through the small cell to a home network, a second identifier component configured to identify a first network bearer corresponding to a link from the small cell to a serving network device, and a mapping component configured to map the first device bearer to the first network bearer to transport data between the first wireless device and the home network.

In another aspect, a computer-readable medium storing computer executable code for using a small cell deployed in a vehicle for transporting data on behalf of a first wireless device is described that includes code for identifying a first device bearer corresponding to a link from the first wireless device through the small cell to a home network, code for identifying a first network bearer corresponding to a link from the small cell to a serving network, and code for mapping the first device bearer to the first network bearer to transport data between the first wireless device and the home network.

In yet another aspect, an apparatus at a small cell deployed in a vehicle for transporting data on behalf of the first wireless device is described that includes means for identifying a first device bearer corresponding to a link from the first wireless device through the small cell to a home network, means for identifying a first network bearer corresponding to a link from the small cell to a serving network, and means for mapping the first device bearer to the first network bearer to transport data between the first wireless device and the home network.

In another aspect, a method at a small cell deployed in a vehicle for identifying the location of a wireless device is described in which a communication with a positioning server (e.g., an enhanced serving mobile location center (E-SMLC)) is enabled using a positioning protocol, wherein the communication is enabled using a wireless backhaul connection to a serving network, a location request is received from the positioning server for the location of the wireless device connected to the small cell and associated with an emergency call, and the positioning server is provided through the communication with the location information. The wireless backhaul connection to the serving network may be based on a wireless local area network (WLAN) (e.g., Wi-Fi) connection.

In another aspect, an apparatus at a small cell deployed in a vehicle for identifying the location of a wireless device is described that includes a communications component configured to enable communication with a positioning server (e.g., an E-SMLC) in a home network using a positioning protocol, wherein the communication is enabled using a wireless backhaul connection to a serving network, a receiver configured to receive a location request from the positioning server for the location of the wireless device connected to the small cell and associated with an emergency call. The apparatus may also include a location information component configured to determine location information for the wireless device. The communications component may be further configured to provide, to the positioning server through the communication, the location information. The wireless backhaul connection to the serving network may be based on a WLAN connection.

In another aspect, a computer-readable medium storing computer executable code for using a small cell deployed in a vehicle for identifying the location of a wireless is described that includes code for enabling communication with a positioning server (e.g., an E-SMLC) in a home network using a positioning protocol, wherein the communication is enabled using a wireless backhaul connection to a serving network, code for receiving a location request from the positioning server for the location of the wireless device connected to the small cell and associated with an emergency call, code for determining location information for the wireless device, and code for providing, to the positioning server through the communication, the location information. The wireless backhaul connection to the serving network may be based on a WLAN connection.

In yet another aspect, an apparatus at a small cell deployed in a vehicle for identifying the location of a wireless device is described that includes means for establishing communication with a positioning server (e.g. an E-SMLC) in a home network using a positioning protocol, wherein the communication is established using a wireless backhaul connection with a serving network and is in response to a location request received by the positioning server for the location of the wireless device connected to the small cell and associated with an emergency call, means for determining location information for the wireless device, and means for providing, to the positioning server through the communication, the location information.

In another aspect, a method at a network device (e.g. a positioning server such as an E-SMLC) in a home network for identifying the location of a wireless device is described in which communication with a small cell deployed in a vehicle is established using a positioning protocol, wherein the communication is established using a wireless backhaul connection to a serving network and is in response to a location request being received at the network device for the location of the wireless device connected to the small cell and associated with an emergency call. The method may also include sending a location request to the small cell for location information for the wireless device, receiving location information for the wireless device from the small cell and determining the location of the wireless device using the location information. The wireless backhaul connection to the serving network may be based on a WLAN connection.

In another aspect, an apparatus at a network device (e.g. a positioning server such as an E-SMLC) in a home network for identifying the location of a wireless device is described that includes a communications component configured to establish communication with a small cell deployed in a vehicle using a positioning protocol, wherein the communication is established using a wireless backhaul connection to a serving network and is in response to a location request being received at the network device for the location of the wireless device connected to the small cell and associated with an emergency call. The communications component may be further configured for sending a location request to the small cell for location information for the wireless device and receiving location information for the wireless device from the small cell. The apparatus may further include a location information component for determining the location of the wireless device using the location information. The wireless backhaul connection to the serving network may be based on a WLAN connection.

In yet another aspect, a computer-readable medium storing computer executable code for using a small cell deployed in a vehicle for identifying the location of a wireless device is described that includes: code for establishing communication with a small cell deployed in a vehicle using a positioning protocol, wherein the communication is established using a wireless backhaul connection to a serving network and is in response to a location request being received for the location of the wireless device connected to the small cell and associated with an emergency call; code for sending a location request to the small cell for location information for the wireless device; code for receiving location information for the wireless device from the small cell; and code for determining the location of the wireless device using the location information. The wireless backhaul connection to the serving network may be based on a WLAN connection.

In another aspect, an apparatus at a network device (e.g. a positioning server such as an E-SMLC) for identifying the location of a wireless device is described that includes: means for establishing communication with a small cell deployed in a vehicle using a positioning protocol, wherein the communication is established using a wireless backhaul connection to a serving network and is in response to a location request being received at the network device for the location of the wireless device connected to the small cell and associated with an emergency call; means for sending a location request to the small cell for location information for the wireless device; means for receiving location information for the wireless device from the small cell; and means for determining the location of the wireless device using the location information. The wireless backhaul connection to the serving network may be based on a WLAN connection.

To the accomplishment of the foregoing and related ends, the one or more aspects comprise the features hereinafter fully described and particularly pointed out in the disclosure. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a conceptual diagram of an example of an access network in which the present aspects may be implemented;

FIG. 2A is a conceptual diagram of an example communications network environment in which the present aspects may be implemented;

FIG. 2B is a conceptual diagram of an example of matching bearers as contemplated by the present disclosure;

FIG. 2C is a protocol layering diagram for an example communications network environment in which the present aspects may be implemented;

FIG. 3A is a flow diagram providing an overview of various aspects of vehicular small cell operations as contemplated by the present disclosure;

FIG. 3B is a flow diagram providing an overview of various other aspects of vehicular small cell operations as contemplated by the present disclosure;

FIG. 3C is a flow diagram providing an overview of aspects of vehicular small cell operations associated with a positioning server as contemplated by the present disclosure;

FIG. 4A is a block diagram providing an overview of various aspects of vehicular small cell operations as contemplated by the present disclosure;

FIG. 4B is a block diagram providing an overview of various aspects of a data transport and emergency services component as contemplated by the present disclosure;

FIG. 4C is a block diagram providing an overview of various aspects of vehicular small cell operations in a positioning server as contemplated by the present disclosure;

FIG. 5 is a block diagram of an example of a small base station in communication with a UE in a telecommunications system in which the present aspects may be implemented;

FIG. 6A is a block diagram of an example of a small cell apparatus, represented as functional modules, according to a present aspect;

FIG. 6B is a block diagram of an example of a positioning server apparatus, represented as functional modules, according to a present aspect;

FIG. 7 is a block diagram of an example of a reference location architecture according to a present aspect;

FIG. 8 is a block diagram of an example of a VSC based reference location architecture according to a present aspect;

FIG. 9 is a flow diagram of an example for LPPa based location retrieval, PSAP routing, according to a present aspect;

FIG. 10 is a flow diagram of an example for LPPa based location retrieval, UE location, according to a present aspect;

FIG. 11 is a block diagram of an example for a UE based location architecture according to a present aspect;

FIG. 12 is a flow diagram of an example for LPP based location retrieval, PSAP routing, according to a present aspect; and

FIG. 13 is a flow diagram of an example for LPP based location retrieval, UE location, according to a present aspect.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As noted above, wireless communications networks are widely deployed to provide various services. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

These multiple access technologies have been adopted in various telecommunication standards to provide common protocols that enable different wireless devices to communicate on a municipal, national, regional, and even global level. An example of a recent telecommunication standard is Long Term Evolution (LTE). LTE is a set of enhancements to the Universal Mobile Telecommunications System (UMTS) mobile standards promulgated by the Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

In cellular networks, where macro base stations are used for connectivity and coverage to a large number of users, a macro cell network deployment is carefully planned, designed, and implemented to offer good coverage over the geographical region served by a particular network operator. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience. Further, macro cell capacity is upper-bounded by physical and technological factors.

For instance, a macro cell may cover a relatively large geographic area, such as, but not limited to, several kilometers in radius. In contrast, a small cell may cover a relatively small geographic area, such as, but not limited to, a home, a building, or a floor of a building. A small cell may include, but is not limited to, an apparatus such as a base station (BS), an access point, a femto node, a femtocell, a pico node, a micro node, a wireless relay station, a Node B, an evolved Node B (eNodeB or eNB), a home Node B (HNB) or a home evolved Node B (HeNB).

Small cells can be deployed for incremental capacity growth, richer user experience, in-building or other specific geographic coverage, and/or the like. The small cell base stations may be connected to the Internet and/or a mobile operator's network via a digital subscriber line (DSL) or a cable modem, for example, often utilizing the existing backhaul infrastructure provided by an Internet Service Provider (ISP) for the residential home or office building in which the small cell base station is installed.

With the introduction of smartphones and tablets in recent years, the amount of data traffic has increased significantly. More and more users consume broadband services (e.g., internet, email, music and video streaming) not only at home, but on the go. One example of such behavior is that users consume significant amounts of broadband services while commuting to work or traveling. Similarly, the demand for broadband internet access in vehicles has also increased and many customers want to enjoy entertainment services on their devices inside vehicles with the same user experience that they are used to at home.

Vehicular Small Cells (VSCs) may be used to provide cellular service to mobile users inside vehicles. Vehicles may include many types of mobile entities in which users may be transported including cars, trucks, mobile homes, trains, boats, airplanes etc. The vehicular environment may be challenging for mobile users because of issues such as shadowing, fast fading, and penetration losses associated with the vehicle body and metal coated windows. By, for example, connecting mobile users wirelessly via the VSC to the vehicle's existing external backhaul antenna, some of these challenges can be overcome, resulting in significantly improved user experience compared to the conventional scenario where users receive service directly on a user portable device (e.g. smartphone, tablet, cellphone, laptop) from the wide area macro cellular network. Mobile network operators may benefit greatly as well, as VSCs connected to antennas on the outside of the vehicle make more efficient use of network resources, resulting in improved network capacity.

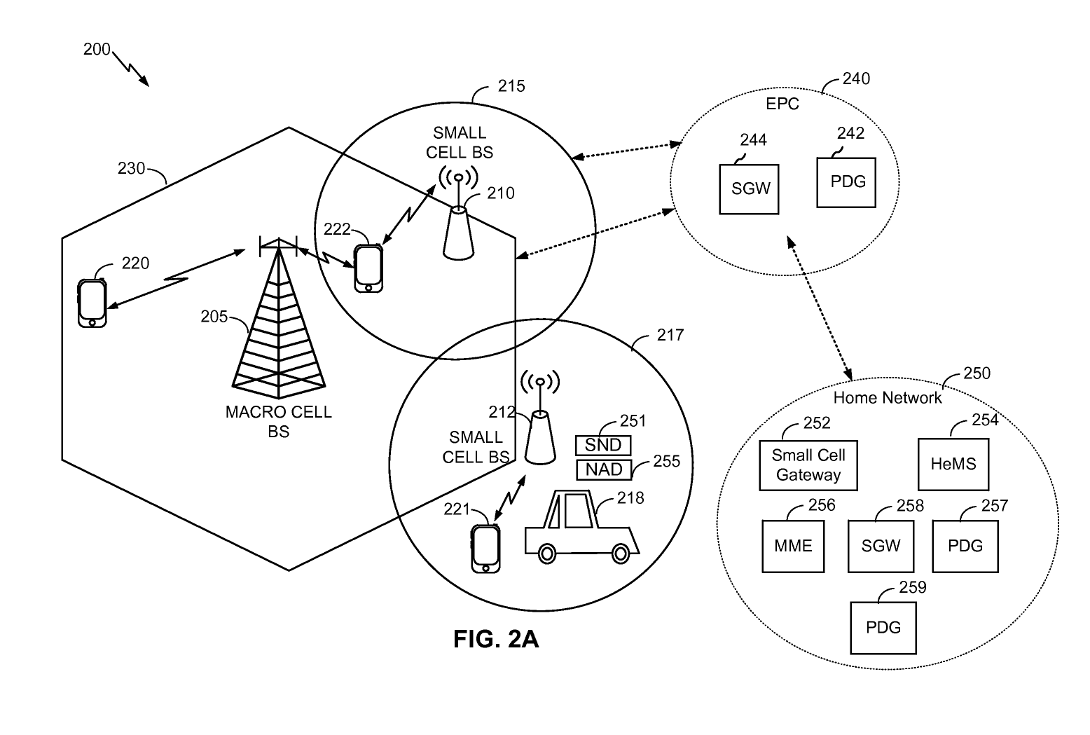

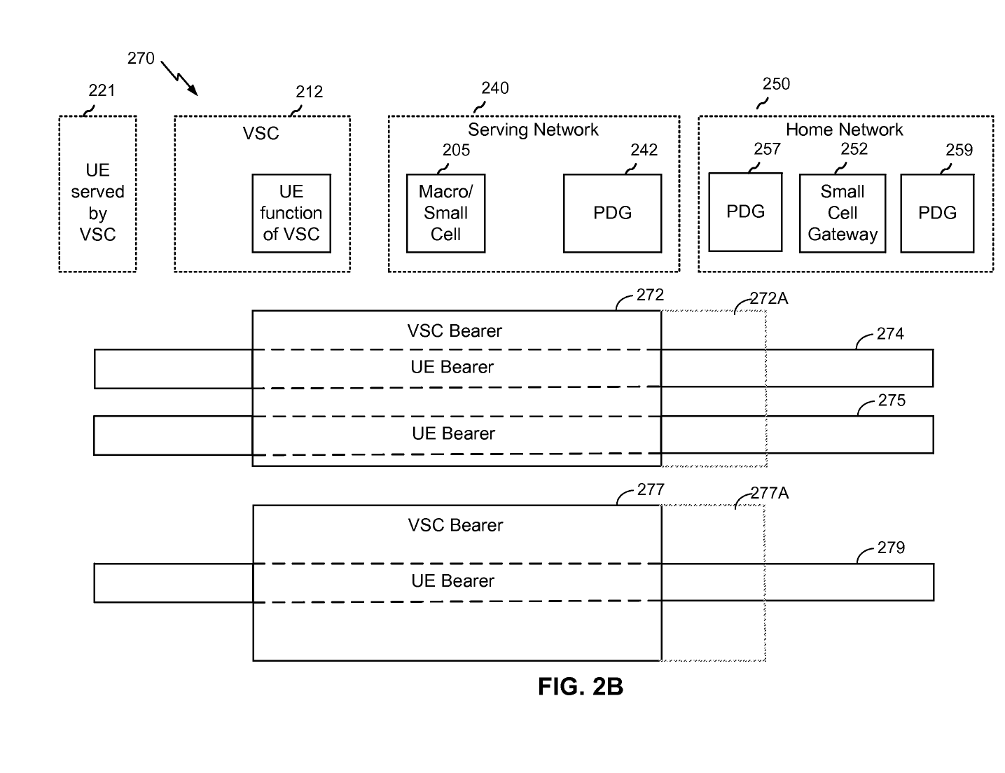

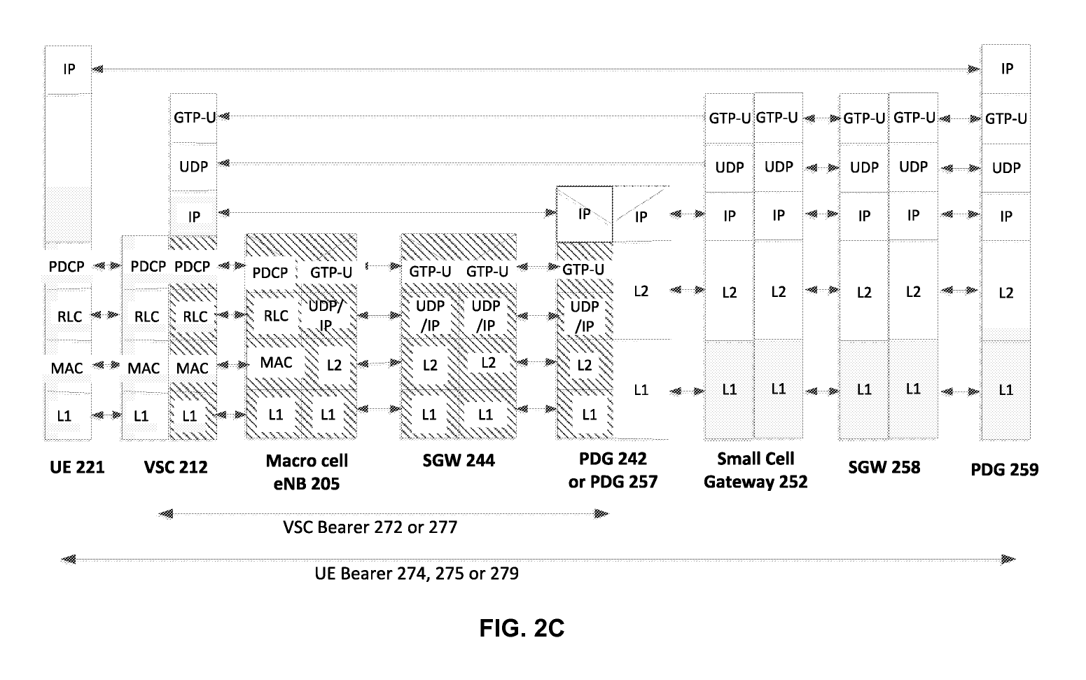

The VSC concept may allow for customer devices (mobile phones, tablets, etc.) to be coupled wirelessly and automatically to the external (e.g., roof-top) vehicle antenna (see, e.g., vehicle 218 in FIG. 2A). This may be achieved by integrating a 3G/4G small cell (e.g. an HNB supporting UMTS or an HeNB supporting LTE) in the vehicle. In contrast to conventional small cells, which are connected to a wired backhaul link, the VSC may be served by a wireless backhaul link. The wireless backhaul between the vehicle and the base station may be handled by a separate cellular (e.g., 3G/4G) device (see, e.g., network access device (NAD) 255 in FIG. 2A). For example, the backhaul connection from the small cell may use a wireless link from an LTE or UMTS radio. Packets carrying data, voice or signaling to support calls or other services for devices connecting on the small cell may be tunneled over the wireless backhaul—e.g., using a GPRS Tunneling Protocol user plane (GTP-U) tunnel over IP as supported for an LTE or UMTS wireless backhaul. This transport is generally transparent to a backhaul wireless link. Similar to a conventional small cell, the VSC may be connected to the cellular mobile core network (data and voice switches) belonging to the operator of the VSC through a standard small cell gateway subsystem (e.g. using an HNB or HeNB Gateway or security Gateway) that serves as a signaling concentrator and may be responsible for operation and maintenance of all VSCs. The wireless backhaul connection may provide the link between the VSC and the small cell gateway subsystem and may replace a DSL (Digital Subscriber Line) or packet cable connection used by a more conventional small cell. In other aspects, the wireless backhaul connection may be established with a wireless local area network (WLAN) (e.g., Wi-Fi) or using a satellite communication system (e.g. in the case of a VSC on boat or airplane).

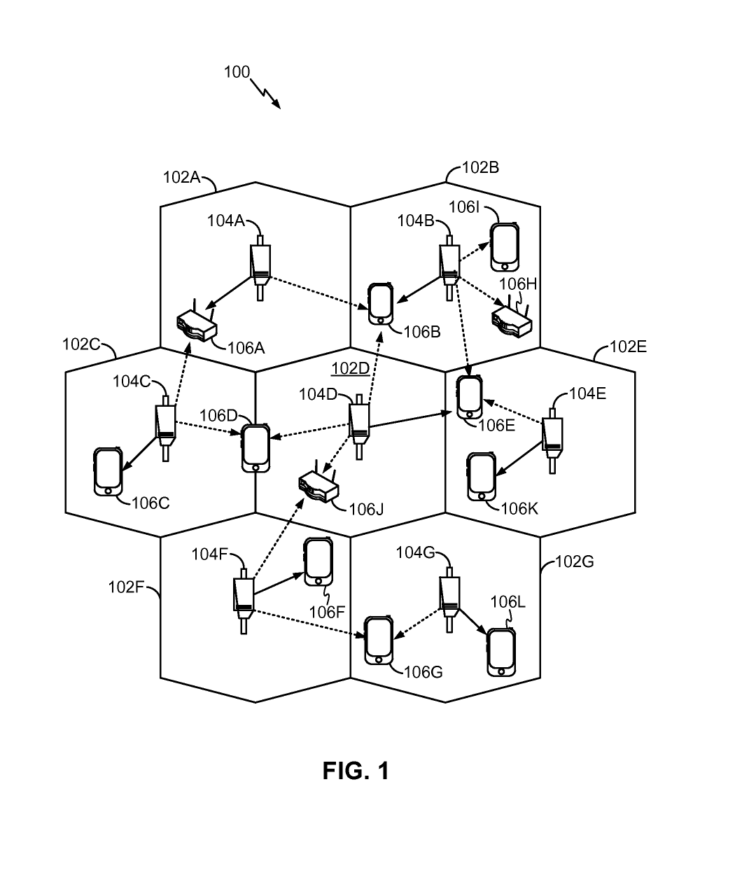

FIG. 1 illustrates an example wireless communications network 100 demonstrating multiple access communications, and in which the present aspects may be implemented. The illustrated wireless communications network 100 is configured to support communication on behalf of a numbers of users. As shown, the wireless communications network 100 may be divided into one or more cells 102, such as the illustrated cells 102A-102G. Communication coverage in cells 102A-102G may be provided by one or more base stations 104, such as the illustrated base stations 104A-104G. In this way, each base station 104 may provide communication coverage to a corresponding cell 102. The base station 104 may interact with a plurality of user devices 106, such as the illustrated user devices 106A-106L.

Each user device 106 may communicate with one or more of the base stations 104 on a downlink (DL) and/or an uplink (UL). In general, a DL is a communication link from a base station to a user device, while an UL is a communication link from a user device to a base station. The base stations 104 may be interconnected by appropriate wired or wireless interfaces allowing them to communicate with each other and/or other network equipment. Accordingly, each user device 106 may also communicate with another user device 106 through one or more of the base stations 104. For example, the user device 106J may communicate with the user device 106H in the following manner: the user device 106J may communicate with the base station 104D, the base station 104D may then communicate with the base station 104B (e.g. via a common core network, not shown in FIG. 1, to which all base stations 104 in FIG. 1 may be connected), and the base station 104B may then communicate with the user device 106H, allowing communication to be established between the user device 106J and the user device 106H.

The wireless communications network 100 may provide service over a large geographic region. For example, the cells 102A-102G may cover a few blocks within an urban neighborhood or tens or even hundreds of square miles in a rural environment. In some systems, each cell 102 may be further divided into two or more sectors (not shown). In addition, the base stations 104 may provide the user devices 106 access within their respective coverage areas to other communications networks, such as the Internet or another cellular network, and to users accessible from these other networks. Each user device 106 may be a wireless communication device (e.g., a mobile phone, router, personal computer, server, tablet, smartphone etc.) used by a user to send and/or receive voice and/or data over a communications network, and may be alternatively referred to as an Access Terminal (AT), a Mobile Station (MS), a Mobile Terminal (MT), a Mobile Device (MD), a Wireless Device, a User Equipment (UE), etc. In the example shown in FIG. 1, user devices 106A, 106H, and 106J comprise routers, while the user devices 106B-106G, 106I, 106K, and 106L comprise mobile phones. Again, however, each of the user devices 106A-106L may comprise any suitable communication device.

For their wireless air interfaces, each base station 104 may operate according to one of several Radio Access Technologies (RATs) depending on the network in which it is deployed, and may be alternatively referred to as a Node B, evolved NodeB (eNB), etc. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Long Term Evolution (LTE) (which may be referred to as Evolved UTRA (E-UTRA)), IEEE 802.11, IEEE 802.16, IEEE 802.20, Flash-OFDM®, etc. E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The wireless communications network 100, or similar networks, may be used to support aspects of vehicular small cell data transport and emergency services described herein. Moreover, similar networks may generally refer to wireless wide area networks (WWANs) as well as WLANs, including networks that support Wi-Fi communications.

FIG. 2A illustrates an example mixed communications network environment 200 in which small cell base stations (or small cells) are deployed in conjunction with macro cell base stations (or macro cells), and in which the present aspects may be implemented. As discussed above, small cell base stations may be used to provide significant capacity growth, in-building coverage, and in some cases different services than macro cells operating alone, thereby facilitating a more robust user experience. In some instances, small cells (or small cell base stations) may be implemented in cars or other vehicles and may be referred to as Vehicular Small Cells or VSCs. Aspects of the mixed communications network environment 200 may be part of a network such as the wireless communications network 100 in FIG. 1. Moreover, aspects of the mixed communications network environment 200 may support WLAN (e.g., Wi-Fi) communications.

In FIG. 2A, a macro cell base station (BS) 205, which may be a macro eNodeB, may provide communication coverage to one or more user devices, for example, user equipment 220, 221, and 222, within a macro cell coverage area 230 (as discussed above in more detail with reference to FIG. 1), while small cell base stations 210 and 212 may provide their own communication coverage within respective small cell coverage areas 215 and 217, with varying degrees of overlap among the different coverage areas. It is noted that certain small cells may be restricted in some manner, such as for association and/or registration, and may therefore be referred to as Closed Subscriber Group (“CSG”) cells. In this example, at least some user devices, e.g., user equipment 222, may be capable of operating both in macro environments (e.g., macro areas) and in smaller scale network environments (e.g., residential, femto areas, pico areas, etc.) as shown. In an aspect, macro cell BS 205 and/or small cell BSs 210 and 212 may each correspond to one of the base stations 104 in FIG. 1 and each of UEs 220-222 may correspond to one of the user devices 106 in FIG. 1.

Turning to the illustrated connections in more detail, user equipment or UE 220 may generate and transmit a message via a wireless link to the macro cell base station 205, the message including information related to various types of communication (e.g., voice, data, multimedia services, etc.) and/or information (referred to as control signaling here) to control and support communication. User equipment 222 may similarly communicate with small cell base station 210 via a wireless link, and user equipment 221 may similarly communicate with small cell base station 212 via a wireless link. The macro cell base station 205 may also communicate with a corresponding Evolved Packet Core (EPC) 240 via a wired backhaul link or via a wireless backhaul link (also referred to herein as a wireless backhaul connection). The EPC 240 may function as a serving network for LTE. The small cell base stations 210 and/or 212 may also similarly communicate with the EPC 240, via their own wired or wireless backhaul links or through wired or wireless links to a macro cell base station, such as macro BS 205, and then via the backhaul link of this macro BS. The EPC 240 may include a Packet Data Network (PDN) gateway (PDG) 242 and a Serving Gateway (SGW) 244. The EPC 240 may enable data, voice and/or control signaling transport between the user equipments 220, 221, and 222, and a home network 250 for the UEs 220-222 in the event that EPC 240 is a serving network but not a home network for UEs 220-222. While the EPC 240 is shown as an example of a serving LTE network for UEs 220-222, the disclosure is not so limited and other types of serving networks may be used based on the types of communications technologies supported by the mixed communications network environment 200 which may include UMTS, W-CDMA, cdma2000, IEEE 802.11 as well as other technologies. The home network 250 may include a small cell gateway 252, an HeNB management system (HeMS) 254, a mobility management entity (MME) 256, and two PDN gateways (PDGs) 257 and 259 (which in some cases may be the same PDG).

As described above, macro cell base station 205 and/or either or both of small cell base stations 210 and 212 may be connected to the EPC 240 using any of a multitude of devices or methods. These connections may be referred to as the “backbone” or the “backhaul” of the network, and may in some implementations be used to manage and coordinate communications between macro cell base station 205, small cell base station 210, and/or small cell base station 212. In this way, depending on the current location of user equipment 222, for example, user equipment 222 may access the EPC 240 via macro cell base station 205 or via small cell base station 210. In some aspects, the “backbone” or “backhaul” connections may be based on WLAN communications and/or on satellite communications.

As illustrated in FIG. 2A, small cell base station 212 may be associated with a vehicle 218 and may therefore operate as a VSC or as part of a VSC. In some aspects, one or more small cell base stations that are associated with a network (e.g., mixed communications network environment 200) may be used and configured to operate as a VSC or as part of a VSC. These small cell base stations may then be configured to provide data transport and emergency services functionality as described herein for VSCs. Small cell base station 212 is referred to herein as “VSC 212” when functioning as a VSC. VSC 212 may be owned and operated by a cellular network operator such as the operator for EPC 240 or the operator for Home Network 250. In this example, VSC 212 is assumed to be owned and operated by Home Network 250, but the example can also describe the case where VSC 212 is owned and operated by EPC 240 if EPC 240 and Home Network 250 are part of the same network and are not separate networks.

The VSC 212 as shown in FIG. 2A may contain a user equipment (UE) function able to access a macro base station such as macro base station 205 or a small cell base station such as small cell base station 210. The UE function may be a separate physical component of VSC 212 (e.g. may be a separate hardware chip) or may be a separate logical component supported on a common hardware platform. The UE function may correspond to the network access device 255 shown in FIG. 2A. The UE function may attach to a serving network (e.g. the EPC 240 in the case of a serving LTE network) and establish one or more user plane data connections (e.g. PDN connections with associated data bearers in the case of LTE) to a gateway in either the serving network (e.g. PDN gateway 242 in the case of LTE) or home network 250 (e.g. PDG 257). In the case of a PDN connection to a PDG in the Home Network 250, the PDN connection may be supported (e.g. routed via) the SGW 244 in the serving EPC 240. In the case of a PDN connection to a PDG in the serving EPC 240, the PDN connection may also be supported (e.g. routed via) the SGW 244 in the serving EPC 240. The VSC 212 may then establish an IP connection through the gateway (e.g. PDG) in the serving network or home network to the small cell gateway 252 (e.g. an HeNB security gateway in the case of a VSC that provides LTE access to its UEs) located in the home network 250 for the VSC. Using the IP connection to the small cell gateway 252 in the home network, the VSC 212 may then (a1) connect to the HeMS 254 for the home network 250, (a2) register as an HeNB with the HeMS 254 and (a3) set up a 3GPP LTE 51 connection to the MME 256 in the home network 250 via the small cell gateway 252 (and possibly via an additional HeNB gateway, not shown in FIG. 2A, that may be needed if small cell gateway 252 supports security but not HeNB gateway functions) to complete attachment to the home network as a small cell. The connection of VSC 212 to the home network 250 as just described may make use of architecture, procedures and protocols that have been defined in 3GPP Technical Specification (TS) 36.300 to support the establishment of connectivity from a small cell base station to the home network for the small cell using wireline means. For example, the parts of the procedure described herein associated with a1, a2 and a3 above may follow the procedures in 3GPP TS 36.300. The difference in the procedure described herein is that VSC 212 also establishes a wireless backhaul connection via the UE function in VSC 212 which differs from the procedure defined by 3GPP in TS 36.300.

The home network (e.g., home network 250) in FIG. 2A would typically correspond to the operator who owns and manages the VSC 212 as described previously which would normally also be the home network for any UEs accessing the VSC 212. The serving network (e.g., EPC 240) would be any network providing local wireless coverage to the current location of the VSC 212. Normally the home and serving networks would be the same network when the VSC 212 is in coverage of its home network; this corresponds to the case described previously wherein home network 250 and EPC 240 are parts of the same network. Otherwise, the home and serving networks will be different. When the home and serving networks are different, the connection from the gateway in the serving network (e.g. SGW 244 or PDG 242) to the small cell gateway 252 in the home network 250 could be via the Internet. Otherwise, when the two networks are the same or belong to the same operator, the Internet may not be used. Also as illustrated in FIG. 2A, the vehicle 218 may have other associated devices that may be used in connection with, for example, emergency services functionality. The satellite navigation device (SND) 251 may be configured to be operated with the vehicle 218 and to provide satellite (or other form of triangulated/trilaterated) navigation or location information, including navigation or location coordinates. The network access device (NAD) 255 may be configured to be operated with the vehicle 218 and to provide a wireless backhaul link for communications from the VSC 212 to a wide area macro cellular network.

The usage of, for example, an LTE/UMTS wireless backhaul can pose challenges for the data, voice and signaling transport associated with a VSC. There are generally two kinds of bearers supported by a VSC for the type of wireless backhaul connection exemplified in FIG. 2A: bearers set up for the UEs connected to or otherwise served by the VSC, which may be referred to as “UE bearers” or “device bearers” and will be supported by the home network, and bearers set up for the backhaul connecting the VSC to the serving network, which may be referred to as “VSC bearers” or “network bearers” and will be supported by the serving network. Data and voice transported on behalf of the UEs connected with the VSC are transported within the UE bearers. The UE bearers need in turn to be transported within VSC bearers. One issue that arises concerns how the UE bearers are to be mapped or encapsulated into VSC bearers; another issue concerns when the VSC bearers are to be set up.

An example 270 of the mapping of UE bearers to VSC bearers is illustrated in FIG. 2B for the UE 221, the VSC 212, serving network 240 and home network 250 in FIG. 2A in the case that (i) the UE 221 is inside the vehicle 218 and served by the VSC 212 and (ii) a PDN connection to support wireless backhaul from the VSC 212 is supported by a PDG (e.g. PDG 242) in the serving network 240 rather than in the home network 250. If the PDN connection for the VSC 212 was instead supported by a PDG (e.g. PDG 257) in the home network 250, then the VSC bearers 272 and 277 in FIG. 2B would extend further to the right in FIG. 2B as far as the PDG 257 in FIG. 2B as shown by the dashed extensions 272A and 277A in FIG. 2B. There may be three types of mapping of VSC bearer to UE bearer: (1) a one-to-one mapping, (2) a one-to-many mapping, and (3) a hybrid mapping. A general assumption for each of these mappings is that the VSC is powered on.

In the one-to-one mapping, each UE bearer is mapped into a distinct VSC bearer (different to the VSC bearer used by any other UE bearer) and any time a UE bearer is set up or removed a corresponding VSC bearer is set up or removed. This mapping may be performed by the VSC 212 in the case of a UE initiated UE bearer establishment procedure or possibly by the gateway in the serving network 240 (e.g. PDG 242) or in the home network (e.g. PDG 257) in case of a network-initiated UE bearer establishment procedure. As noted above, FIG. 2B illustrates how the bearers are related. A VSC bearer 272 is shown as a thick pipe starting in the UE function of the VSC 212 and extending through a macro or small cell BS (e.g., macro cell base station 205 or small cell base station 210) of the serving network 240 to the gateway (e.g., PDN gateway 242) in the serving network where the VSC bearer ends. If the gateway is supported in the home network 250, the VSC bearer 272 continues via the extension 272A to the gateway (e.g. PDG 257) in the home network 250. A UE bearer 274 is shown as a thinner pipe starting in a UE served by the VSC 212 (e.g., user equipment 221 in FIG. 2B) and extending through the VSC 212 and into one particular VSC bearer (thick pipe), in this example VSC bearer 272. At the gateway (e.g., PDG 242 for a serving network gateway or PDG 257 for a home network gateway), the UE bearer 274 emerges from the VSC bearer 272 (or from the extension 272A) and extends (e.g. via the Internet in the case of a serving network gateway) through the small cell gateway 252 in the home network and through an SWG 258 in the home network 250 (not shown in FIG. 2B) to the PDG 259 in the home network 250 that has been assigned by the home network 250 to support a PDN connection for the UE (e.g. UE 221) where the UE bearer 274 then ends. Data/voice IP packets sent by the UE (e.g. UE 221) transported within the UE bearer 274 can then be transported from the home network PDG 259 over the Internet to one or more remote endpoints (e.g. other UEs). Similarly, data/voice packets received from other UEs over the Internet can be transported to the UE (e.g. UE 221) within the UE bearer 274 that is itself transported within the VSC bearer 272.

A protocol layering that may be used to support any of the UE bearers 274, 275 and 279 in FIG. 2B when transported inside the associated VSC bearer 272 or 277 shown in FIG. 2B is shown in FIG. 2C where the shaded protocol layers supported by the VSC 212, macro cell eNB 205, SGW 244 and PDG 242 or 257 support a VSC bearer (e.g. VSC bearer 272 or 277) and the other unshaded protocol layers below the IP layer at the top of the diagram support a UE bearer (e.g. UE bearer 274, 275 or 279). The protocol layering shown in FIG. 2C is based on the protocol layering for LTE access defined in 3GPP TS 23.401 and TS 36.300 and uses abbreviations for the different protocol layers that are used and defined in these 3GPP TSs and shown below in Table 1. However, unlike these 3GPP TSs, the protocol layering shown in FIG. 2C supports UE bearers transported within VSC bearers, where the VSC bearers are supported by a wireless backhaul as described previously herein.

TABLE 1
Protocol Abbreviations

| | |
|---|---|
| GTP | GPRS Tunneling Protocol |
| GTP-U | GTP for user data |
| IP | Internet Protocol |
| L1 | Layer 1 |
| L2 | Layer 2 |
| MAC | Media Access Control |
| PDCP | Packet Data Convergence Protocol |
| RLC | Radio Link Control |
| UDP | User Datagram Protocol |

The three mapping alternatives referred to above each map UE bearers 274 to VSC bearers 272 in different ways. For example, FIG. 2B also shows multiple UE bearers 274 and 275 mapped to the same VSC bearer 272, where UE bearer 275 is also mapped to the VSC bearer 272; this is an example of the one-to-many mapping. In addition, FIG. 2B also shows multiple VSC bearers being used for mapping. In this case, in addition to VSC bearer 272, VSC bearer 277 (and its possible extension 277A) is used for mapping UE bearer 279—in this example via a one-to-one mapping.

For the one-to-many mapping, all UE bearers for the same UE or for all UEs served by VSC 212 may be mapped into the same VSC bearer. The VSC may set up a PDN connection when it is switched on (or upon first UE attach to the VSC) and all the UE bearers are mapped into the default bearer of the set up PDN connection.

For the hybrid mapping, the VSC 212 and/or the PDG 242 or PDG 257 attempt to use a one-to-many mapping but may set up new VSC bearers if needed for Quality-of-Service (QoS). For example, a large file transfer may probably not share a VSC bearer with voice or video. FIG. 2B shows an example of a hybrid mapping since both a one-to-one mapping and a one-to-many mapping are supported by the VSC 212 for the same UE 221.

A further extension of the backhaul QoS associated with the VSC could consist in performing the mapping of the required QoS at the access link (e.g. to/from the UE 221 inside the vehicle 218, served by the VSC 212) into a corresponding QoS bearer on the wireless backhaul link. To be able to provide such mechanisms, an exchange of information between the VSC 212 and NAD 255 needs to be in place. This way, upon request of a UE 221 served by the VSC 212 to setup a dedicated radio bearer with certain QoS, the information may be propagated via an appropriate application programming interface (API) over the VSC 212 interface to the NAD 255 that can trigger the same action over the backhaul link. These enhancements may require the deployment of UE initiated QoS functionality and may require a more sophisticated VSC interface which could possibly work better in case of an integrated VSC/NAD solution.

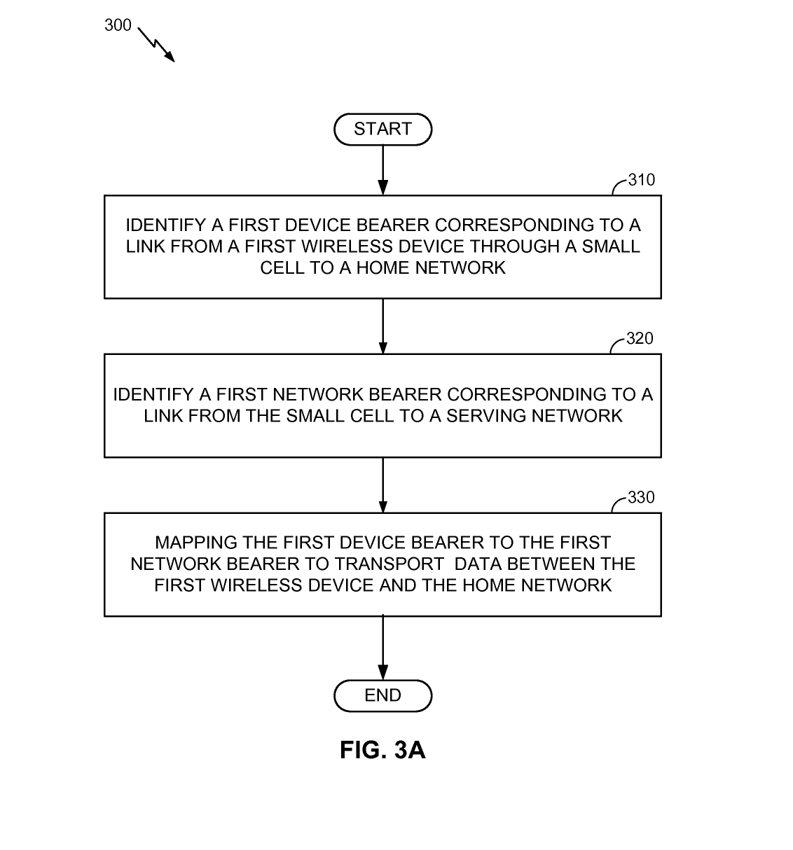

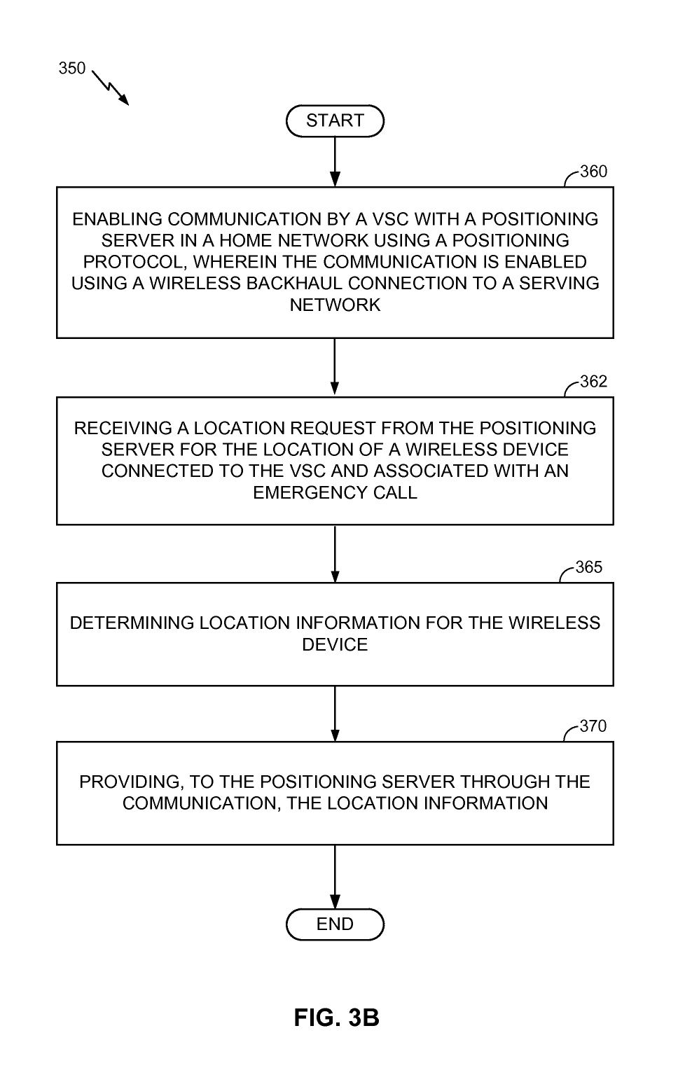

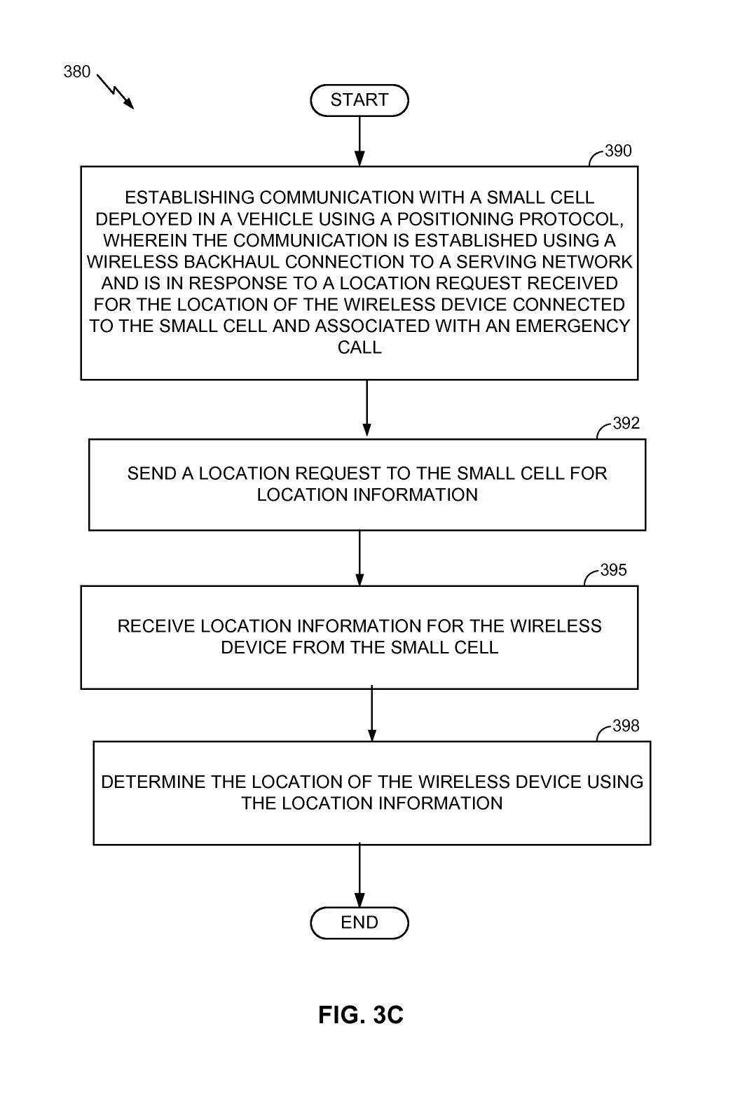

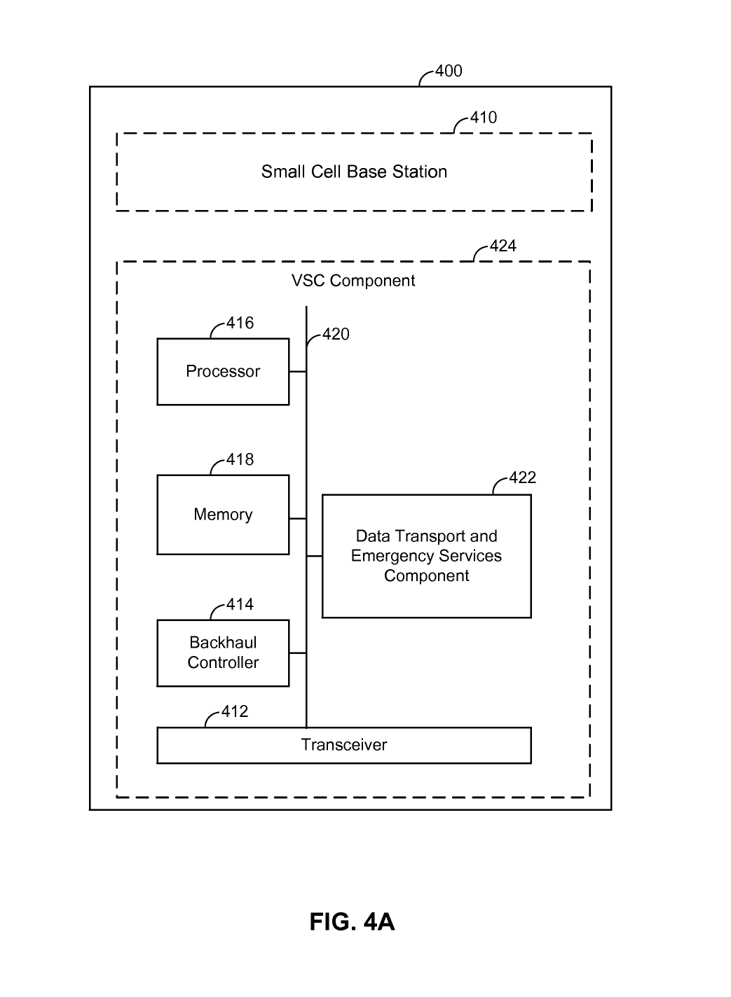

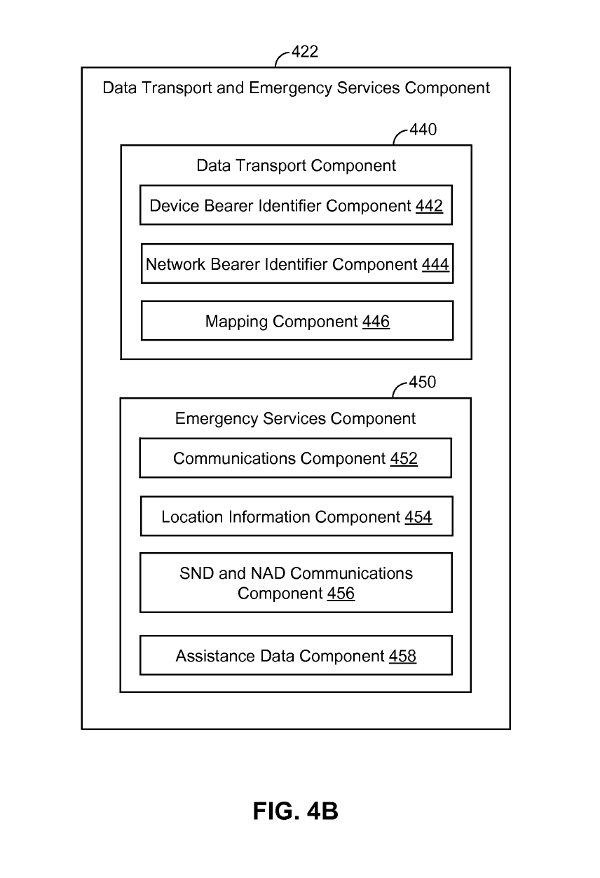

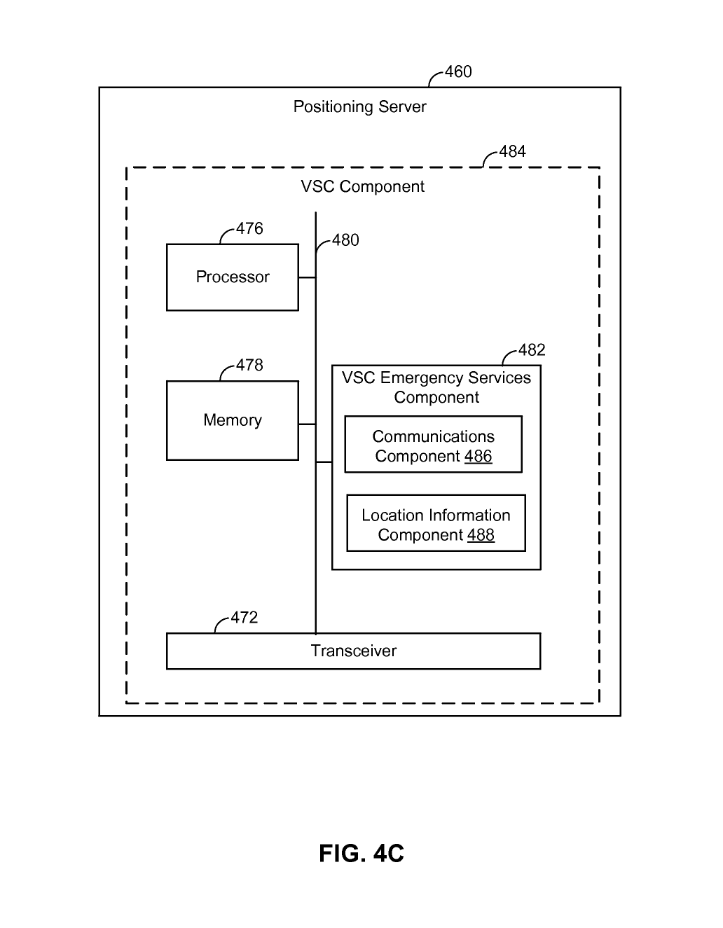

FIG. 3A is a flow diagram illustrating an example methodology 300 used in an aspect of VSC for data transport that supports different types of bearer mapping. In an aspect, at block 310, methodology 300 for use at a small cell deployed in a vehicle for transporting data on behalf of a first wireless device may include identifying a first device bearer corresponding to a link from the first wireless device through a small cell to a home network (e.g. home network 250). For example, a data transport component 440 and/or a device bearer identifier component 442 (FIG. 4B) may identify the first device bearer.

At block 320, methodology 300 may include identifying a first network bearer corresponding to a link from the small cell to a serving network. For example, the data transport component 440 and/or a network bearer identifier component 444 (FIG. 4B) may identify the first network bearer.

At block 330, methodology 300 may include mapping the first device bearer to the first network bearer to transport data between the first wireless device and the home network. For example, the data transport component 440 and/or a mapping component 446 (FIG. 4B) may map the first device bearer to the first network bearer.

In one aspect of the methodology 300, the serving network may be the same as the home network. In another aspect of the methodology 300, the EPC 240 in FIG. 2A may be an example of the serving network when the serving network is a serving LTE network, the home network 250 in FIG. 2A may be an example of the home network, the VSC 212 associated with vehicle 218 in FIG. 2A may be an example of the small cell deployed in the vehicle, and the UE 221 may be an example of the first wireless device. In yet another aspect of the methodology 300, the UE bearers 274, 275, and 279 in FIG. 2B may be examples of device bearers and the VSC bearers 272 and 277 in FIG. 2B may be examples of network bearers.

Another aspect of the methodology 300 may include setting up the first network bearer when the first device bearer is set up. The first device bearer may be set up in response to an indication from the home network. The first device bearer may be set up in response to an indication from the first wireless device.

Another aspect of the methodology 300 may include identifying a second device bearer corresponding to a link from one of the first wireless device and a second wireless device through the small cell to the home network, and mapping the second device bearer to the first network bearer to transport data between the one of the first wireless device and the second wireless device and the home network.

Another aspect of the methodology 300 may include identifying a second device bearer corresponding to a link from one of the first wireless device and a second wireless device through the small cell to the home network, identifying a second network bearer corresponding to the link from the small cell to the serving network, and mapping the second device bearer to the second network bearer to transport data between the one of the first wireless device and the second wireless device and the home network. The second network bearer may be set up when the second device bearer is set up.

Another aspect of the methodology 300 may include establishing a connection between the small cell and a packet data network gateway associated with the serving network, wherein the connection is established when the small cell is powered on or when an initial wireless device attaches to the small cell, and wherein the first network bearer is a default bearer of the connection.

Another aspect of the methodology 300 may include identifying a third device bearer corresponding to a link from one of the first wireless device, the second wireless device, and a third wireless device through the small cell to the home network, identifying a second network bearer corresponding to the link from the small cell to the serving network, and mapping the third device bearer to the second network bearer to establish communications between the one of the first wireless device, second wireless device, and third wireless device and the home network.

In yet another aspect of the methodology 300, a QoS of the first device bearer may correspond to the QoS of the first network bearer. Also, the link from the small cell to the serving network may include a wireless backhaul link provided by a network access device in the serving network communicatively coupled to the small cell. In addition, the first wireless device may be operated within the vehicle.

In addition to the data transport aspects of VSCs described above, the enabling of emergency services in a VSC involves other issues such as having UE location provisioning for public safety answering point (PSAP) routing and UE location after call set up. In macro networks, UE location provisioning may be based upon UE initiated procedures providing the network with latitude/longitude coordinates (if available) or UE assisted location procedure (either control or user plane) in which a UE provides a network (e.g. a location server or positioning server in the network) with measurement information allowing determination of a location for the UE by the network (e.g. by a location or positioning server in the network). In a VSC, however, the above procedures may not always apply because a UE served by a VSC may be unable to determine its location or provide measurement information to a network due to attenuation and reflection of RF signals from nearby base stations and from satellites caused by the vehicle within which the UE is located. In addition, any cell ID and tracking area code (TAC) assigned by the home network to the VSC and provided to a location server in the home network to help determine the location of the UE may not have any geographical significance (in contrast to a cell ID and TAC for a normal fixed cell) due to the mobility of the VSC.

Aspects of addressing the UE position for emergency services (e.g., an emergency call) may involve the use of a global positioning system (GPS) or other global navigation satellite system (GNSS) receiver (e.g., SND 251 in FIG. 2) that is co-located in the vehicle and able to obtain an accurate location that is available to the VSC. In some embodiments, the GPS or GNSS receiver may be part of the VSC. The GPS or GNSS receiver may have an external antenna positioned outside the vehicle (e.g. on the roof of a car or truck) that has less restricted access to satellite positioning signals than a wireless device inside the vehicle and can therefore obtain a more reliable and accurate location. The VSC may also employ sensors (e.g. accelerometers, gyroscopes, magnetometers) to obtain location when out of GPS or other GNSS coverage (e.g. when in a parking garage or tunnel). Because battery life may not be an issue, the VSC may always have an up-to-date location, thereby enabling a location to be provided by the VSC without delay and thus avoiding delays in using the location to route an emergency call from the UE to a suitable PSAP or providing the location in response to a request (e.g. a rebid request) from a PSAP. The location of the vehicle that is available to the VSC may be requested by a location or positioning server in the home network (e.g. an enhanced serving mobile location center (E-SMLC)) using the LTE Positioning Protocol A (LPPa) defined by 3GPP in 3GPP TS 36.455. Since the VSC is treated by the home network as a small cell or HeNB, the positioning server may employ existing LTE capability (e.g. as defined in 3GPP technical specifications 36.305 and 36.455) to request the location of the VSC from the VSC using LPPa. This may be triggered when the positioning server is requested to obtain the location of a UE due to an emergency call from the UE and the positioning server is able to recognize the serving cell for the UE as corresponding to a cell supported by a VSC (e.g. by assigning reserved cell IDs and/or TACs to VSCs that have been configured in the location server as corresponding to VSCs). Specific functionalities such as PSAP routing and UE location after call set-up may then be supported. Moreover, if the UE is able to determine its own location or obtain location measurement information, then it is possible to fall back to UE terminated procedures should a location from the VSC not be available.

The location of the vehicle that is provided by the VSC to the positioning server may be treated by the positioning server as a good approximation for the location of the wireless device. This may be valid when the vehicle is small (e.g. a car or truck). For a large or long vehicle (e.g. a train or boat) where the location obtained by the VSC is that of the VSC, the VSC may make measurements of signals received from the wireless device and determine a distance to the wireless device and/or a direction. The VSC may then determine a location of the wireless device relative to the VSC and combine this relative location with the location of the VSC to yield a more accurate location for the wireless device. This more accurate location may then be provided to a positioning server—e.g. when the positioning server requests location information for the wireless device using LPPa. Alternatively, the VSC may provide (e.g. using LPPa) any measurements of signals received from the wireless device to the positioning server along with the location of the VSC (e.g. determined by the VSC using GPS or GNSS). The positioning server may then determine the location of the wireless device relative to the VSC using the measurements provided by the VSC and may combine this with the location of the VSC and thereby obtain a more accurate location of the wireless device.

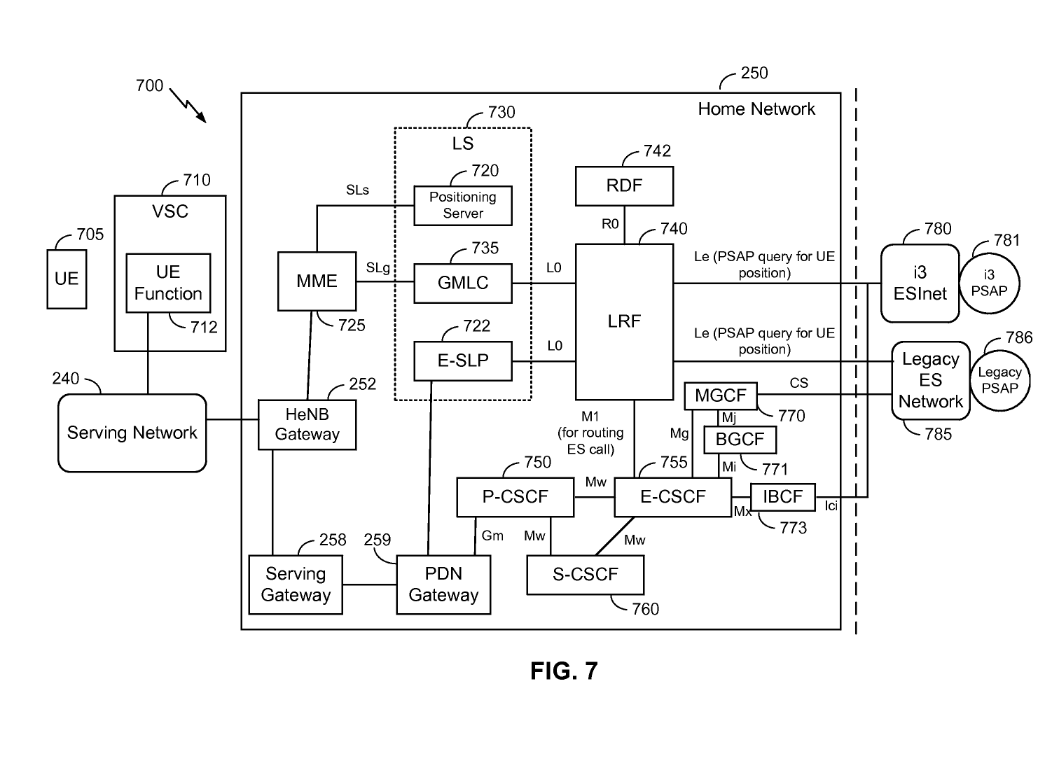

FIG. 3B is a flow diagram illustrating an example methodology 350 used in an aspect of VSC for emergency services (e.g., eCall/E911). In an aspect, at block 360, methodology 350 may include the VSC enabling communication with a positioning server (see, e.g., positioning server 720 in FIG. 7) in a home network using a positioning protocol, wherein the communication is enabled using a wireless backhaul connection to a serving network. For example, an emergency services component 450 and/or a communications component 452 (FIG. 4B) may enable communication with the positioning server. At block 362, the VSC receives a location request from the positioning server for the location of a wireless device connected to the VSC and associated with an emergency call. The location request may be according to the positioning protocol and may be received using the communication enabled in block 360.

At block 365, methodology 350 may include the VSC determining location information for the wireless device. The location information may comprise the location coordinates of the VSC, location coordinates of the vehicle and/or location measurements for the wireless device (e.g. a round trip signal propagation time, signal strength, signal angle of arrival). For example, the emergency services component 450 and/or the location information component 454 (FIG. 4B) may determine the location information (e.g., location coordinates of the VSC) for the wireless device.

At block 370, methodology 350 may include providing, to the positioning server, the location information determined at block 365 which may be used by the positioning server to determine the location of the wireless device. For example, the emergency services component 450 and/or the location information component 454 (FIG. 4B) may provide the location information to the positioning server. The location information may be provided according to the positioning protocol and may be sent using the communication enabled in block 360.

In an aspect of the methodology 350, the VSC may correspond to VSC 212, the wireless device may correspond to UE 221, the home network may correspond to home network 250 and the serving network may correspond to serving EPC 240 in FIGS. 2A-2C. In an aspect, the positioning protocol may be LPPa. In an aspect, the positioning server may be an E-SMLC.

Another aspect of the methodology 350 may include having the positioning server selected by a mobility management entity (MME) (see, e.g., MME 725 in FIG. 7). In an aspect, the MME may select the positioning server in response to either (i) a location request for the wireless device from a PSAP that is forwarded within the home network to the MME, or (ii) an emergency attach procedure between the wireless device and the MME.

Another aspect of the methodology 350 may include having the location request include information indicating that the location request refers to the VSC. In this aspect, the positioning server may determine that the wireless device is being served by a VSC (i.e. by a small cell deployed in a vehicle) and not by a fixed cell due to receiving (e.g. from an MME or from the VSC) a tracking area code (TAC) and/or a cell identity (CI) assigned to the VSC when the VSC is initially registered in the home network. The TAC and/or CI may indicate a VSC. For example, the TAC and/or CI may contain a reserved value or values (e.g. reserved digits) assigned by the home network operator and/or may belong to a reserved range assigned by the home network operator that indicate a VSC as opposed to a fixed cell which may trigger the positioning server to send a request (e.g. an LPPa request) to the VSC for the location of the VSC.

Another aspect of the methodology 350 may include receiving satellite positioning coordinates for the VSC from a satellite navigation device communicatively coupled to the VSC, wherein the location of the VSC (or of the associated vehicle) comprises the satellite positioning coordinates. The VSC may provide, to the positioning server through the communication and using the positioning protocol, the satellite positioning coordinates as at least part of the location information for the wireless device. Note that the terms “positioning server” and “location server” are interchangeable and are used synonymously herein.

Another aspect of the methodology 350 may include the VSC requesting assistance data from a Secure User Plane Location (SUPL) Location Platform (SLP) in the home network or some other network, receiving the assistance data, and using the assistance data to help determine the location of the VSC (e.g., using measurements of GPS satellites or measurements of nearby base stations).

FIG. 3C is a flow diagram illustrating an example methodology 380 used at a location server (e.g. an E-SMLC) to obtain the location of a wireless device served by a small cell deployed in a vehicle (e.g. a VSC). The location may be obtained to locate the wireless device in association with an emergency services call (e.g., eCall/E911). In an aspect, at block 390, methodology 380 may include establishing communication with the small cell using a positioning protocol, wherein the communication is established using a wireless backhaul connection to a serving network and is in response to a location request received by the location server for the location of the wireless device connected to the small cell and associated with an emergency call. For example, a VSC component 484, a VSC emergency services component 482, and/or a communications component 486 (FIG. 4C) may establish a communication with the small cell. In some aspects, the wireless device may be operated within the vehicle.

At block 392, methodology 380 may include sending a location request to the small cell for location information for the wireless device. The location request may be sent using the communication established at block 390 and according to the positioning protocol. In an aspect, the location request may request a location and/or location measurements for the wireless device. In another aspect, the location request may request the location of the small cell, based on receiving an indication that the small cell is deployed in a vehicle (e.g. is a VSC). The indication that the small cell is deployed in a vehicle may be based on receiving a tracking area code (TAC) and/or a cell ID (CI) for the small cell, in either the location request received at block 390 or from the small cell, that indicate a VSC. For example, the TAC and/or CI may contain a reserved value or values (e.g. reserved digits) assigned by the home network operator and/or may belong to a reserved range assigned by the home network operator that indicate a VSC as opposed to a fixed cell. For example, the VSC component 484, the VSC emergency services component 482, and/or a communications component 486 (FIG. 4C) may send the location request to the small cell.

At block 395, the location server may receive location information for the wireless device from the small cell. In an aspect, if the location server requested the location of the small cell at block 392, the location information may comprise the location (e.g. location coordinates) of the small cell or of the vehicle in which the small cell is deployed. In another aspect, if the location server requested location information for the wireless device, the location information may comprise the location of the wireless device, location measurements for the wireless device obtained by the small cell and/or the location of the small cell or of the vehicle. For example, the VSC component 484, the VSC emergency services component 482, and/or a communications component 486 (FIG. 4C) may receive the location information for the wireless device.

At block 398, the location server may determine the location of the wireless device using the location information received at block 395. For example, the VSC component 484, the VSC emergency services component 482, and/or a location information component 488 (FIG. 4C) may determine the location of the wireless device.

In an aspect of the methodology 380, the small cell may correspond to VSC 212, the wireless device may correspond to UE 221, the home network may correspond to home network 250 and the serving network may correspond to serving EPC 240 in FIGS. 2A-2C. In an aspect, the positioning protocol may be LPPa. In an aspect, the location server may be an E-SMLC. In this aspect, the E-SMLC may be selected by an MME in the home network (e.g., MME 725 in FIG. 7) in response to either (i) a location request for the wireless device from a PSAP that is forwarded within the home network to the MME, or (ii) an emergency attach or emergency PDN procedure between the wireless device and the MME.

FIG. 4A illustrates an aspect of a vehicular small cell (VSC) 400 in which a small cell base station 410 is enhanced by adding a VSC component 424. The VSC 400 may correspond to the VSC 212 in FIGS. 2A-2C and/or to the VSC that performs the example methodologies 300 and 350. In one aspect, the VSC component 424 may comprise the various elements 412, 414, 416, 418, 420 and 422 shown in FIG. 4A. In another aspect, one or more of elements 412, 414, 416, 418, 420, and 422 may belong to or be shared with the small cell base station 410 and may be used to support functions performed by VSC component 424. In an aspect, the VSC component may physically reside inside the small cell base station 410—e.g. may be implemented using additional firmware and/or software running on existing hardware components of small cell base station 410. In an aspect, the term “component” as used herein may be one of the parts that make up a system, may be hardware and/or software, and may be divided into other components.

In general, the VSC 400, small cell base station 410 and/or VSC component 424 includes various components for providing and processing data transport and emergency services. For example, the small cell base station 410 and/or VSC component 424 may include a transceiver 412 for wireless communications and a backhaul controller 414 for backhaul communications. The transceiver 412 and backhaul controller 414 may support a UE function to enable VSC component 424 or small cell base station 410 to attach to a serving wireless network and establish a wireless backhaul connection to a home network as described in relation to FIGS. 2A-2C. These components may operate under the direction of processor 416 in conjunction with memory 418, for example, all of which may be interconnected via a bus 420 or the like.

In an aspect, the small cell base station 410 and/or VSC component 424 may further include a data transport and emergency services component 422 that may be configured to enable the small cell base station 410 and/or VSC component 424 to perform the various VSC operations described herein. The functions and/or operations of the data transport and emergency services component 422 may be performed, at least in part, by or in connection with the processor 416 and/or the memory 418.

FIG. 4B illustrates an aspect of the data transport and emergency services component 422 of FIG. 4A. The data transport and emergency services component 422 may include a data transport component 440 having the device bearer identifier component 442, the network bearer identifier component 444, and the mapping component 446 described above with respect to the methodology 300 in FIG. 3A.

The data transport and emergency services component 422 may also include an emergency services component 450 having the communications component 452 and the location coordinates component 454 described above with respect to the methodology 350 in FIG. 3B. The emergency services component 450 may also include an SND and NAD communications component 456 configured to send and/or receive information from, for example, devices such as the SND 251 and NAD 255 in FIG. 2A. While component 456 is shown to support communications with both SND 251 and NAD 255, component 456 may be configured to support communications with one of SND 251 and NAD 255, and a different component in the emergency services component 458 may be configured to support communications with the remaining one of SND 251 and NAD 255. The emergency services component 450 may also include an assistance data component 458 for requesting and handling assistance data from SUPL SLP in a specific set of networks, for example.

In some implementations, the data transport component 440 may be implemented in the data transport and emergency services component 422 without the emergency services component 450 or with the emergency services component 450 being disabled. In other implementations, the emergency services component 450 may be implemented in the data transport and emergency services component 422 without the data transport component 440 or with the data transport component 440 being disabled.

FIG. 4C illustrates an aspect of a positioning server 460 that may be enhanced by adding a VSC component 484. The positioning server 460 may be, for example, an E-SMLC. In one aspect, the VSC component 484 may comprise the various elements 472, 476, 478, 480 and 482 shown in FIG. 4C. In another aspect, one or more of elements 472, 476, 478, 480, and 482 may belong to positioning server 460 and may be used to support functions performed by VSC component 484.

In general, the positioning server 460 and/or VSC component 484 includes various components for providing and processing signaling and information for requesting and handling location information associated with emergency services. For example, the positioning server 460 or VSC component 484 may include a transceiver 472, a processor 476, and a memory 478 that communicate over at least one bus 480 to identify the location of a wireless device for different emergency situations.

In an aspect, the positioning server 460 and/or VSC component 484 may further include a VSC emergency services component 482 having the communications component 486 and the location information component 488. The functions and/or operations of the VSC emergency services component 482 may be performed, at least in part, by or in connection with the processor 476 and/or the memory 478.

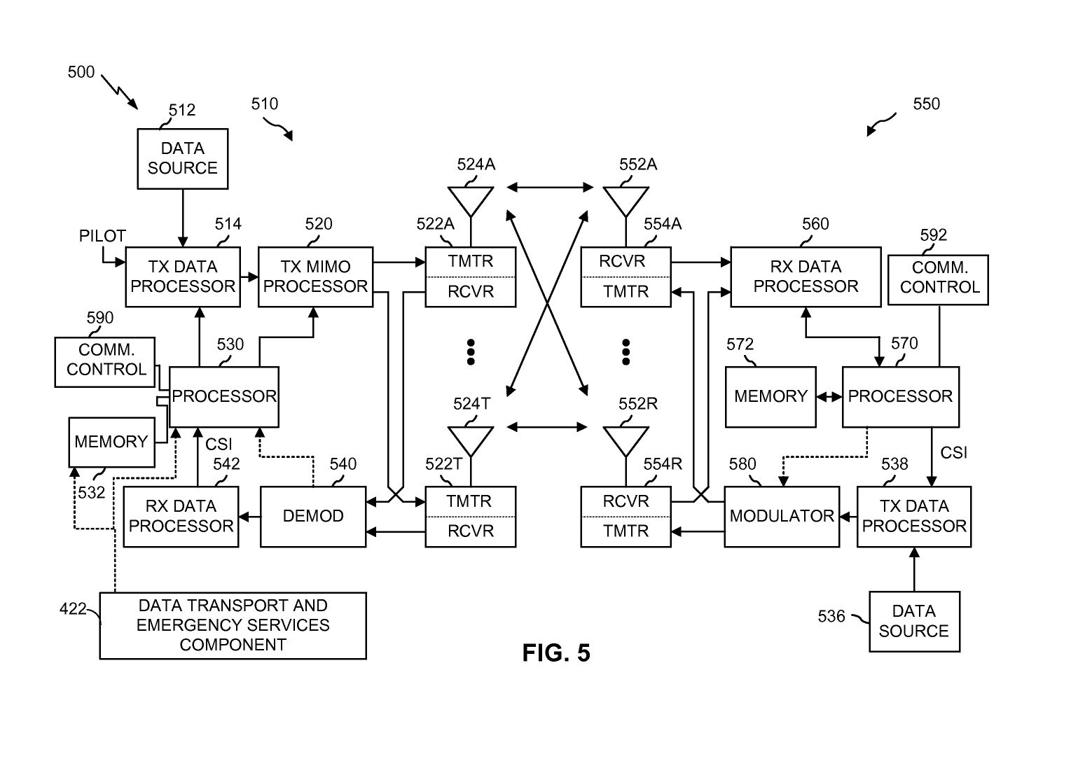

FIG. 5 illustrates in more detail the principles of wireless communication between a wireless device 510 (e.g., small cell base station or VSC such as VSC 212), including data transport and emergency services component 422 (FIG. 4A), and a wireless device 550 (e.g., a user equipment or UE such as UE 221 in FIGS. 2A-2C) of a sample communications system 500 that may be adapted as described herein. In an aspect, wireless device 510 may correspond to a base station (e.g. macro cell base station 205 in FIG. 2A) and wireless device 550 may correspond to a UE function in a VSC—e.g. the UE function in the VSC 212 shown in FIG. 2B or the network access device (NAD) 255 shown in FIG. 2A: this aspect may be applicable to establishing a wireless backhaul connection from a VSC to a serving network as described in association with FIGS. 2A-2C. In an aspect, the functionality of the data transport and emergency services component 422 may be in one or more modules or instructions within processor 530, or within computer readable instructions stored in memory 532 and executable by processor 530, or some combination of both.

At the device 510, traffic data for a number of data streams is provided from a data source 512 to a transmit (TX) data processor 514. Each data stream may then be transmitted over a respective transmit antenna.

The TX data processor 514 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 530. A data memory 532 may store program code, data, and other information used by the processor 530 or other components of the device 510.

The modulation symbols for all data streams are then provided to a TX MIMO processor 520, which may further process the modulation symbols (e.g., for OFDM). The TX MIMO processor 520 then provides NT modulation symbol streams to NT transceivers (XCVR) 522A through 522T. In some aspects, the TX MIMO processor 520 applies beam-forming weights to the symbols of the data streams and to the antenna from which the symbol is being transmitted.

Each transceiver 522 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 522A through 522T are then transmitted from NT antennas 524A through 524T, respectively.

At the device 550, the transmitted modulated signals are received by NR antennas 552A through 552R and the received signal from each antenna 552 is provided to a respective transceiver (XCVR) 554A through 554R. Each transceiver 554 conditions (e.g., filters, amplifies, and down converts) a respective received signal, digitizes the conditioned signal to provide samples, and further processes the samples to provide a corresponding “received” symbol stream.

A receive (RX) data processor 560 then receives and processes the NR received symbol streams from NR transceivers 554 based on a particular receiver processing technique to provide NT “detected” symbol streams. The RX data processor 560 then demodulates, deinterleaves, and decodes each detected symbol stream to recover the traffic data for the data stream. The processing by the RX data processor 560 is complementary to that performed by the TX MIMO processor 920 and the TX data processor 514 at the device 510.

A processor 570 periodically determines which pre-coding matrix to use (discussed below). The processor 570 formulates a reverse link message comprising a matrix index portion and a rank value portion. A data memory 572 may store program code, data, and other information used by the processor 570 or other components of the device 550.

The reverse link message may comprise various types of information regarding the communication link and/or the received data stream. The reverse link message is then processed by a TX data processor 538, which also receives traffic data for a number of data streams from a data source 536, modulated by a modulator 580, conditioned by the transceivers 554A through 554R, and transmitted back to the device 510.

At the device 510, the modulated signals from the device 550 are received by the antennas 524, conditioned by the transceivers 522, demodulated by a demodulator (DEMOD) 540, and processed by a RX data processor 542 to extract the reverse link message transmitted by the device 550. The processor 530 then determines which pre-coding matrix to use for determining the beam-forming weights then processes the extracted message.

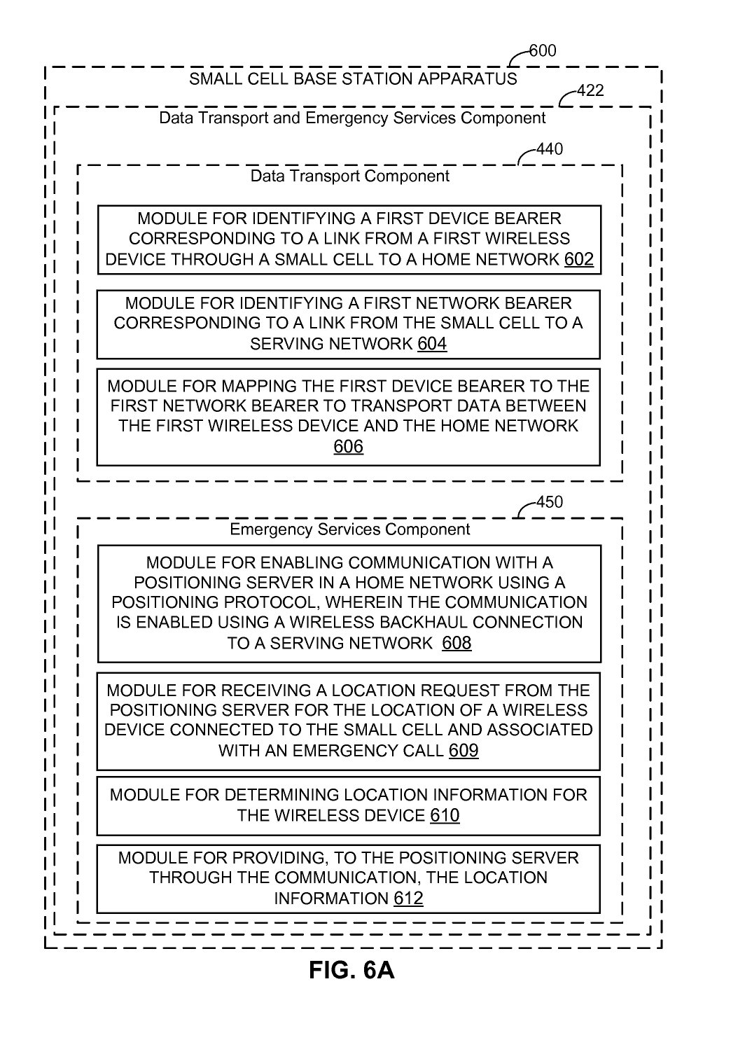

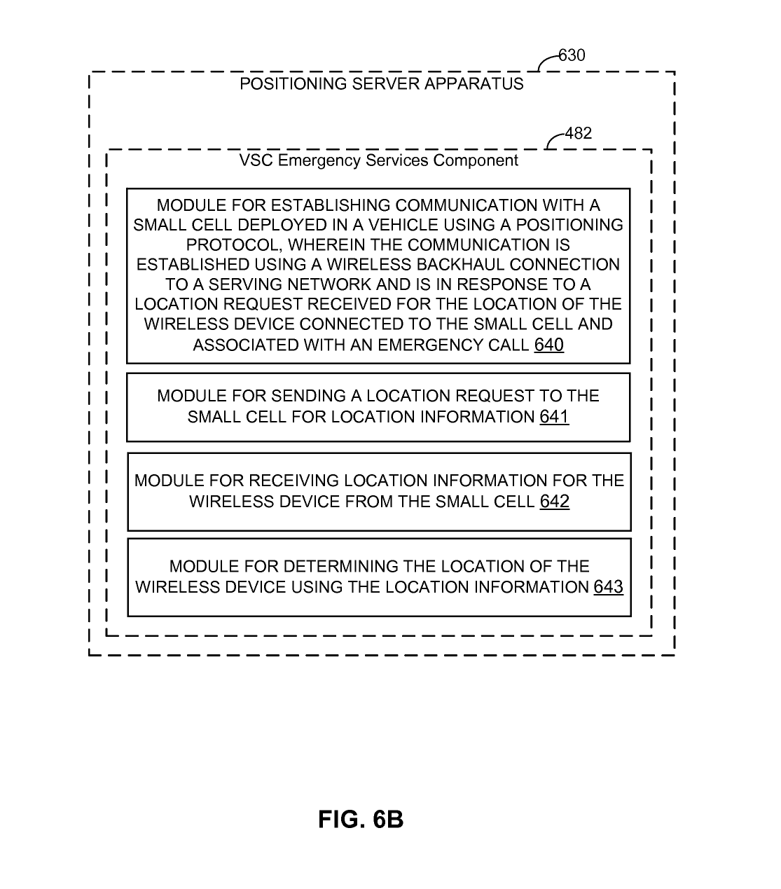

FIG. 6A illustrates an example small cell base station apparatus 600, including data transport and emergency services component 422, data transport component 440, and emergency services component 450, represented as one or more functional modules. The small cell base station apparatus 600 may correspond to the VSC 212 described in FIGS. 2A-2C and/or a VSC that supports the methodologies 300 and 350 in FIGS. 3A and 3B. In an aspect, small cell base station apparatus 600, data transport and emergency services component 422, and/or data transport component 440 may include a module 602 for identifying a first device bearer corresponding to a link from a first wireless device through a small cell to a home network, a module 604 for identifying a first network bearer corresponding to a link from the small cell to a serving network, and a module 606 for mapping the first device bearer to the first network bearer to transport data between the first wireless device and the home network. Modules 602, 604, and 606 may respectively correspond to functionality supported by the device bearer identifier component 442, the network bearer identifier component 444, and the mapping component 446 in FIG. 4B, and/or functionality described in connection with FIG. 3A.

In an aspect, small cell base station apparatus 600, data transport and emergency services component 422, and/or emergency services component 450 may include a module 608 for enabling communication with a positioning server (e.g., E-SMLC) in a home network using a positioning protocol, wherein the communication is enabled using a wireless backhaul connection to a serving network, a module 609 for receiving a location request from the positioning server for the location of a wireless device connected to the small cell and associated with an emergency call, a module 610 for determining location information for the wireless device, and a module 612 for providing, to the positioning server through the communication, location information for the wireless device. Modules 608, 609, 610, and 612 may support the functionality provided by the communications component 452 and the location information component 454 in FIG. 4B and/or functionality described in connection with FIG. 3B.

FIG. 6B illustrates an example positioning server apparatus 630, including VSC emergency services component 482, represented as one or more functional modules. In an aspect, positioning server apparatus 630 and/or VSC emergency services component 482 may include a module 640 for establishing communication with a small cell deployed in a vehicle using a positioning protocol, wherein the communication is established using a wireless backhaul connection to a serving network and is in response to a location request received by the positioning server apparatus 630 for the location of a wireless device connected to the small cell and associated with an emergency call. The positioning server apparatus 630 and/or VSC emergency services component 482 may include a module 641 for sending a location request to the small cell for location information for the wireless device. The positioning server apparatus 630 and/or VSC emergency services component 482 may include a module 642 for receiving the location information for the wireless device from the small cell, and a module 643 for determining the location of the wireless device using the location information. Modules 640, 641, 642, and 643 may correspond to functionality supported by the communications component 486 and the location information component 488 in FIG. 4C and/or functionality described in connection with FIG. 3C.

The functionality of the module(s) of FIGS. 6A and 6B may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIGS. 6A and 6B as well as other components and functions described herein, may be implemented using any suitable means. Such means also may be implemented, at least in part, using corresponding structure as taught herein. For example, the components described above in conjunction with the “module for” components of FIGS. 6A and 6B also may correspond to similarly designated “means for” functionality. Thus, in some aspects one or more of such means may be implemented using one or more of processor components, integrated circuits, or other suitable structure as taught herein.

As described above, there is a benefit for a VSC solution in which small cells are used in cars and other vehicles. In order to comply with the same regulatory requirements satisfied by 3G/4G networks currently deployed, a VSC solution may support emergency services, e.g. support E911 calls for a UE served by a VSC and fulfill different regulatory requirements set in different countries for emergency services. These requirements may include PSAP routing: the emergency call initiated by the UE is routed to the correct PSAP. Typically, the correct PSAP is the PSAP closest to the UE placing the emergency call or a PSAP that may be more distant but serves an area that includes the location of the UE. Regulatory requirements may also include UE location provisioning: some countries require that the UE location is provided to the emergency center (e.g., PSAP).

Solutions deployed in 3G/4G macro networks solving the above requirements rely on Radio Access Network (RAN) or UE provisioned information (e.g., Cell-Id for LTE) to support PSAP routing and location of a UE by an E-SMLC or SUPL SLP on behalf of a PSAP. An illustration of the major entities involved in supporting PSAP routing and location of a UE in the case of a VSC that supports LTE access from UEs on behalf of an LTE home network is shown in system 700 of FIG. 7.

The system 700 may include a UE 705 in communication with a VSC 710 that includes a UE function 712. UE 705 may correspond to UE 221 and VSC 710 may correspond to VSC 212 in FIGS. 2A-2C. The VSC 710 may perform the functions described herein for data transport and emergency calls. The system 700 may also include at least a portion of a serving network such as the serving network 240 (e.g., EPC) and at least a portion of a home network such as the home network 250. The home network 250 may include a serving gateway 258 and a PDN gateway 259. The home network 250 may also include a small cell gateway such as a HeNB gateway 252. Like numbered elements in FIGS. 2A-2C and FIG. 7 may correspond to one another—e.g. PDN Gateway 259 in FIG. 7 may correspond to PDG 259 in FIGS. 2A-2C. The VSC 710 may have a backhaul wireless connection through the serving network 240 to the HeNB gateway 252. The system 700 may also include an MME 725, which may be in communication with the HeNB gateway 252 and a location system (LS) 730 that includes a positioning server 720 (e.g., E-SMLC), a gateway mobile location center (GMLC) 735, and an emergency secure user plane location (SUPL) location platform (E-SLP) 722. The GMLC 735 and E-SLP 722 may communicate with a location retrieval function (LRF) 740, which in turn may use a routing determination function (RDF) 742. The LRF 740 may be configured to receive and respond to a query about the position or location of the UE 705 from network 780 (e.g., i3 ESInet) or network 785 (legacy ES network). The network 780 may have an associated public safety answering point (PSAP) 781 (e.g., i3 PSAP) and the network 785 may have an associated PSAP 786 (e.g., legacy PSAP).

In another aspect of system 700, FIG. 7 also shows a proxy call session control function (P-CSCF) 750 in communication with the PDN gateway 259, which in turn is also in communication with the E-SLP 722 in the LS 730. The P-CSCF 750 may provide an entry point for an IP multimedia subsystem (IMS) domain. The P-CSCF 750 may communicate with a serving CSCF (S-CSCF) 760 and an emergency CSCF (E-CSCF) 755. Also shown in FIG. 7 are a media gateway control function (MGCF) 770, which can communicate with the network 785, as well as a breakout gateway control function (BGCF) 771 and an interconnection border control function (IBCF) 773, which can communication with the network 780.

The role of entities involved in UE location architecture in system 700 are generally as follows:
LRF (Location Retrieval Function) 740, generally configured to determine a correct PSAP or correct entity on the PSAP side for routing of an emergency voice over IP (VoIP) call from UE 705 when requested by E-CSCF 755 and configured to obtain a current location of UE 705 when requested by a PSAP by passing a location request to either GMLC 735 or E-SLP 722 and providing any location result back to the PSAP;
E-CSCF (Emergency Call Session Control Function) 755: generally configured to route an emergency VoIP call from UE 705 to or towards a PSAP, making use of PSAP routing information obtained from LRF 740;
MME 725, generally configured to invoke a location session with positioning server 720 in order to obtain the location of the UE 705 when a control plane location solution is used to locate UE 705 and when a location request for UE 705 is either received (e.g. from GMLC 735) or triggered (e.g. by UE 705 attaching to MME 725 or requesting a PDN connection from MME 725 for an emergency call);
GMLC (Gateway Mobile Location Centre) 735 generally configured to initiate location of UE 705 using a control plane location solution by sending a location request to MME 725 when requested to obtain the location of UE 705 by LRF 740; also configured to receive an unsolicited location for UE 705 from MME 725 when an emergency call begins and transfer the location to LRF 740;
E-SLP (Emergency Secure User Plane Location (SUPL) Location Platform) 722: generally configured to obtain the location of a UE such as UE 705 using the SUPL user plane location solution when requested by LRF 740;
Positioning server 720, generally configured to manage the overall co-ordination and scheduling of resources required for the location of a UE such as UE 705 that is attached via LTE access (e.g. via VSC 710) when a control plane location solution is used and when a location request is received from MME 725; and
PSAP: may comprise a legacy PSAP (e.g., PSAP 786) that supports emergency calls using circuit mode or an IP capable (i3) PSAP (e.g., PSAP 781) that supports E911 calls using VoIP and Session Initiation Protocol (SIP) signaling according to the National Emergency Number Association (NENA) i3 standard.

Solutions previously used in 3G/4G macro networks for supporting VoIP emergency calls from a UE 705 may not be directly applied to VSC 710, as the cell-ID assigned to VSC 710 by the home network 250 and conveyed to the UE 705 may not be mapped against any fixed location information. Normally, the cell ID assigned to an eNB serving a UE will be conveyed in a SIP INVITE message sent by the UE 705 to P-CSCF 750 and E-CSCF 755 in FIG. 7 to initiate establishment of an emergency call via the home LTE network. The E-CSCF 755 will then query the LRF 740 for PSAP routing information and provide the received cell ID to LRF 740. The LRF 740 would then use some database to find a PSAP destination or some intermediate destination on the PSAP side corresponding to the cell ID and would return this to E-CSCF 755 which would then route the call. However, in the case of UE 705 served by VSC 710 (shown in system 700), LRF 740 or the database queried by LRF 740 will not be able to associate a PSAP destination with the received cell ID because VSC 705 does not have a fixed location. To overcome such a challenge, two possible approaches have been identified with the aim of minimizing the impacts to entities deployed in the network. Both identified approaches can be used separately depending on network configuration and capabilities as well as on the local regulatory requirements (a combination of the two approaches is also possible).
VSC based location solution: the VSC 710 provides information for PSAP routing and UE location (VSC 710 may need access to a vehicle GPS or GNSS receiver).
UE based location solution: a UE location (or UE obtained measurements enabling an element in LS 720 to determine a UE location) is (or are) provided to the LS 720 (e.g. to the positioning server 720 or E-SLP 722) directly from the UE 705. The UE provided location is then used to support PSAP routing and location provision to the PSAP.

The UE based location solution relies on the UE being able to obtain measurements of signals from radio sources at known or predictable locations such as GPS or GNSS satellites or fixed base stations but not VSC 710 whose location may be unknown. Such measurements may not always be possible or accurate due to signal attenuation caused by UE 705 being inside a vehicle. The VSC based location solution relies on VSC 710 for providing information required for PSAP routing and UE location by adding VSC location interfaces and protocols. The protocol implementing this solution may be LPPa, or LTE Positioning Protocol A, which then needs to be supported by VSC 710 and positioning server 720.

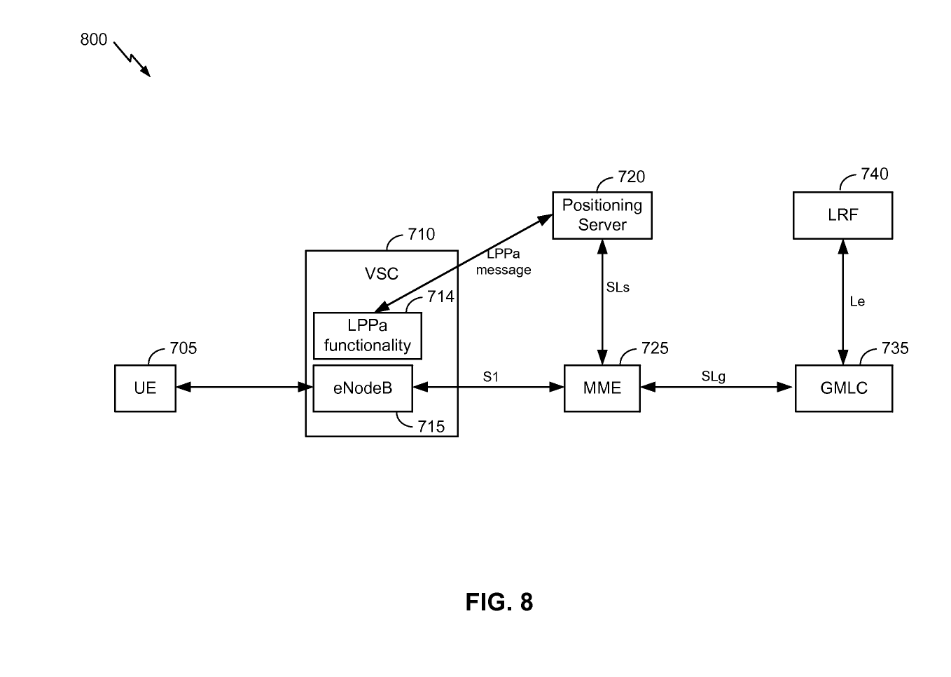

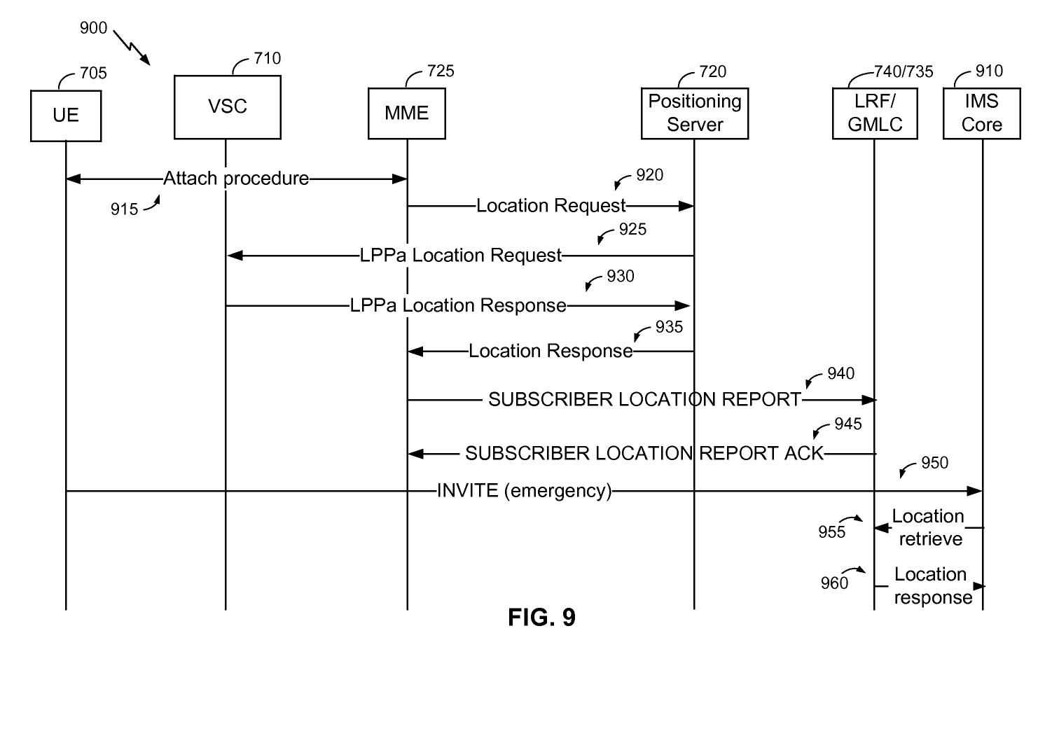

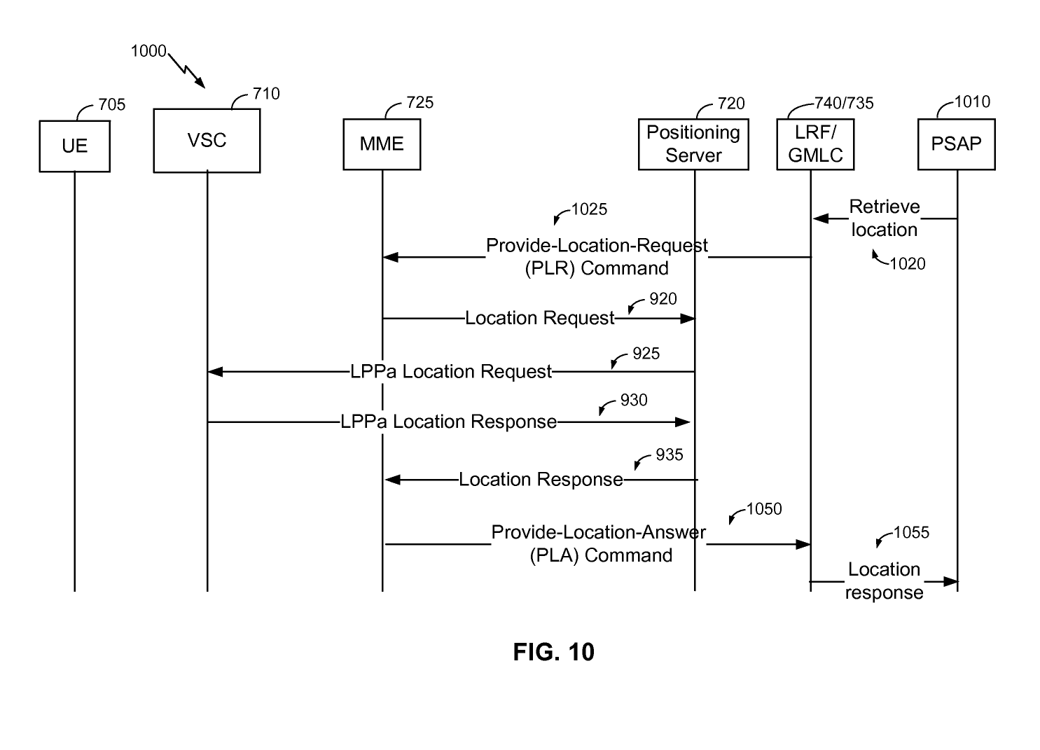

FIG. 8 illustrates a system 800 that shows VSC extensions for location provision using the VSC based location solution and the interactions of VSC 710 with the other functionalities involved in PSAP routing and UE location. System 800 is a subset of system 700 in FIG. 7 in which entities directly involved in supporting the VSC based location solution are shown and correspond to like numbered entities in FIG. 7. FIG. 8 shows VSC 710 as containing two components, which may each be implemented in hardware, software, firmware or some combination of these. The first component is LPPa functionality 714, which may be used to send and receive LPPa messages to and from positioning server 720 (e.g. at steps 925 and 930 in each of FIGS. 9 and 10). The second component is eNodeB component 715, which may be used to provide wireless access to UE 705 and connectivity of UE 705 to the home network 250 and may include the UE function 712 in FIG. 7. The description of message flows 900 and 1000 in FIGS. 9 and 10, respectively, show the interaction among elements in FIG. 8 for the VSC based location solution to support UE location retrieval required by PSAP routing and UE location provision to a PSAP.

In FIG. 9, a user of UE 705 dials an emergency call (not shown in FIG. 9) which leads to an attach procedure or an emergency attach procedure initiated by the UE 705 at step 915 to set up the emergency bearer and emergency PDN connection in the home network. The emergency PDN connection may be used later (e.g. at step 950) to as a means to send and receive messages at the IP level to and from the IMS Core 920 to establish the emergency call. The emergency PDN connection may comprise a UE bearer similar to or the same as any of the UE bearers 274, 275 or 279 shown in FIGS. 2B and 2C previously. The emergency PDN connection may be supported by a VSC bearer similar to or the same as any of VSC bearers 272 or 277 shown in FIGS. 2B and 2C. The VSC bearer may be supported by a wireless backhaul connection from VSC 710 to either serving network 240 or home network 250 as described previously (e.g. in association with FIGS. 2A-2C). The attach procedure or the emergency PDN connection provision may trigger the MME 725 to initiate a location request procedure for UE 705 at step 920. As part of the location request procedure, the MME 725 selects the positioning server 720 (e.g. an E-SMLC) and sends a Location Request message to the selected positioning server 720. The Location Request includes the information required to indicate that the location request refers to a VSC 710. This information may comprise the cell identity (CI) and/or tracking area code (TAC) assigned to VSC 710 which will be known to MME 725 as a consequence of VSC 710 registering earlier with home network 250 as a small cell (or HeNB) and setting up an S1 connection to MME 725 as described for FIG. 2A. The CI and/or TAC assigned to VSC 710 may be part of reserved ranges assigned only to VSCs by the operator of home network 250 or may contain reserved values (e.g. reserved digits) assigned only to VSCs by the operator of home network 250. The reserved ranges or reserved values may be configured in positioning server 720 (e.g. by a home operator Management Function such as an HeMS for VSC 710).

Positioning server 720 detects that the location request message received from MME 725 is for a UE served by a VSC due to determining that the CI and/or TAC for the UE are part of a reserved range assigned to VSCs or contain a reserved value assigned to VSCs. Positioning server 720 then sends a message to VSC 710 at step 925 using the LPPa protocol to request location information for the UE 705. The request may include a request for the location of VSC 710 and possibly a request for information on signal measurements for UE 705 performed by VSC 710. VSC 710 may obtain its location using a GPS or GNSS receiver that is internal or external to VSC 710 and that may have access to GPS or GNSS signals from an antenna external to the vehicle in which VSC 710 is located. VSC 710, functioning as a UE, may also request and receive assistance data (e.g. assistance data for GNSS) from a location server that may differ from positioning server 720 and, which may be either a SUPL SLP in the home network or another positioning server in the home network when VSC 710 is not roaming, to help VSC 710 obtain its current location (not shown in FIG. 9). VSC 710 returns in step 930 its location to positioning server 720 along with any additional measurements of UE 705 requested by positioning server 720. The VSC location obtained by the positioning server 720 may be combined with any additional measurements of UE 705 by VSC 710 that are returned to obtain a more accurate location of UE 705 or positioning server 720 may treat the returned location of VSC 710 as a good approximation for the location of UE 705. The location for UE 705 is provided back by positioning server 720 to the MME 725 at step 935 in the Location Response message.

The MME 725 is now able to provide the LRF/GMLC 740/735 function at step 940 with the UE location and performs such task through a Subscriber Location Report message exchange that includes steps 940 and 945. After this sequence of operations, the LRF/GMLC 740/735 has the UE location and is able (e.g. following step 955 described later) to use the UE location in the LRF to determine the correct PSAP destination or an intermediate destination on the PSAP side to which the emergency call should be routed and can also provide the UE location to the PSAP when later requested by the PSAP.

Once the UE 705 obtains the emergency PDN connection at step 915, the UE 705 performs an emergency registration in the home network (not shown in FIG. 9) and then sends a SIP INVITE message at step 950 for the emergency call to the P-CSCF (e.g. P-CSCF 750 in FIG. 7) and thence to the E-CSCF (e.g. E-CSCF 755) in the IMS core 910 in the home network. The IMS core 910 may comprise the P-CSCF 750, the E-CSCF 755, the LRF 740, the RDF 742, the S-CSCF 760, the IBCF 773, the BGCF 771 and the MGCF 770 in the home network 250 as shown in FIG. 7. If the IMS core 910 (e.g. an E-CSCF such as the E-CSCF 755) requires information to route the IMS session towards the proper PSAP, the IMS core 910 (e.g. E-CSCF) polls the LRF/GMLC 740/735 and through a Location retrieve/response message exchange at steps 955 and 960 the IMS core 910 obtains the information (e.g. the address of a PSAP destination, the address of a PSAP intermediate destination and/or other routing information) for PSAP routing from LRF/GMLC 740/735. The IMS Core 910 may then route the emergency call to or towards the correct destination PSAP and the emergency call may be established between the UE 705 and the PSAP (not shown in FIG. 9). Note that if UE 705 is roaming in another country or in a region for which the home network 250 is unable to route an emergency call to a local PSAP for UE 705, the home network 250 may reject a request from UE 705 to establish an emergency call (e.g. which may occur after step 950 in FIG. 9). Alternatively or in addition, VSC 710 may not provide wireless service to UE 705 when VSC 710 determines that VSC 710 is in another country or in an area where home network 250 is not licensed to provide wireless coverage. In that case UE 705 may attempt to obtain service from another network.

During the emergency session the destination PSAP may require an update of the UE location (e.g., to indicate to public safety responders the location of the user). This is exemplified in message flow 1000 in FIG. 10 which may continue the message flow 900 in FIG. 9 for the emergency call established in message flow 900. UE location retrieval is performed through a Location retrieve/response message exchange at steps 1020 and 1055 between the destination PSAP and the LRF/GMLC 740/735 (see FIG. 10). If the UE location held by LRF/GMLC 740/735 is considered accurate enough (e.g. the UE location was recently retrieved), the LRF/GMLC 740/735 can immediately send the Location response with the UE location at step 1055. Alternatively, the LRF/GMLC 740/735 can poll, using steps 1025 and 1050, the MME 725 used by the UE 705 for an updated UE location. To obtain the UE location, the MME 725 initiates a location request procedure with the same operations as those described in FIG. 9 (see e.g., steps 920, 925, 930, and 935 which may be similar to or the same as steps 920, 925, 930, and 935 described for FIG. 9).

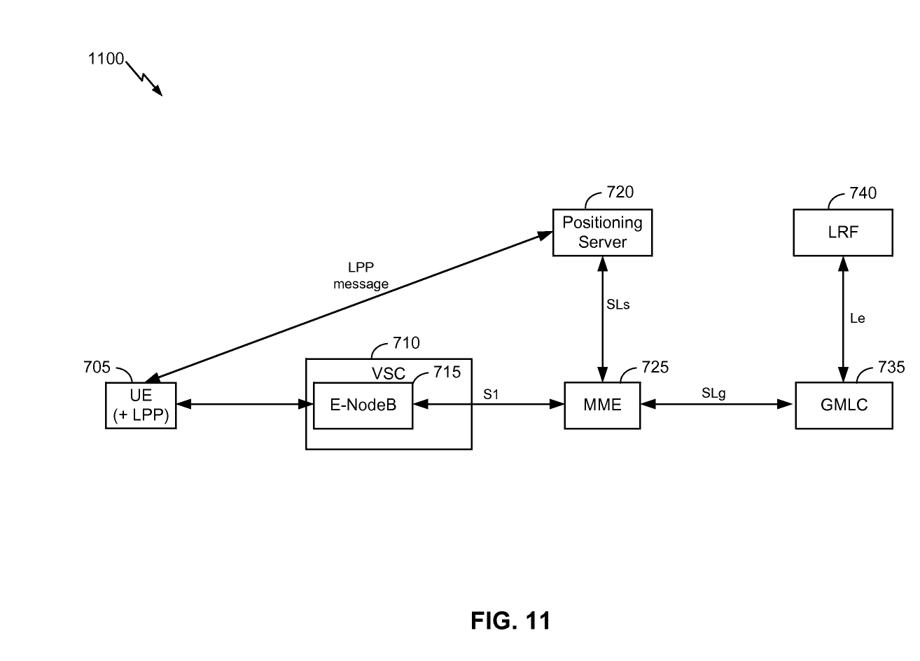

The UE based location solution referred to previously for providing a location of the UE 705 to the positioning server 720 relies on UE extensions for providing information required for PSAP routing and UE location. Several protocols (e.g., control plane based) are candidate solutions for this approach. A control plane solution (LTE Positioning Protocol (LPP)) is used as reference without losing generality with respect to other protocols. FIG. 11 shows a system 1100 for UE extensions for location provisioning and the interactions of VSC 710 with the other functionalities involved in PSAP routing and UE location. Like FIG. 8 above, FIG. 11 is a subset of system 700 in FIG. 7 in which those entities directly involved in supporting the UE based location solution are shown.

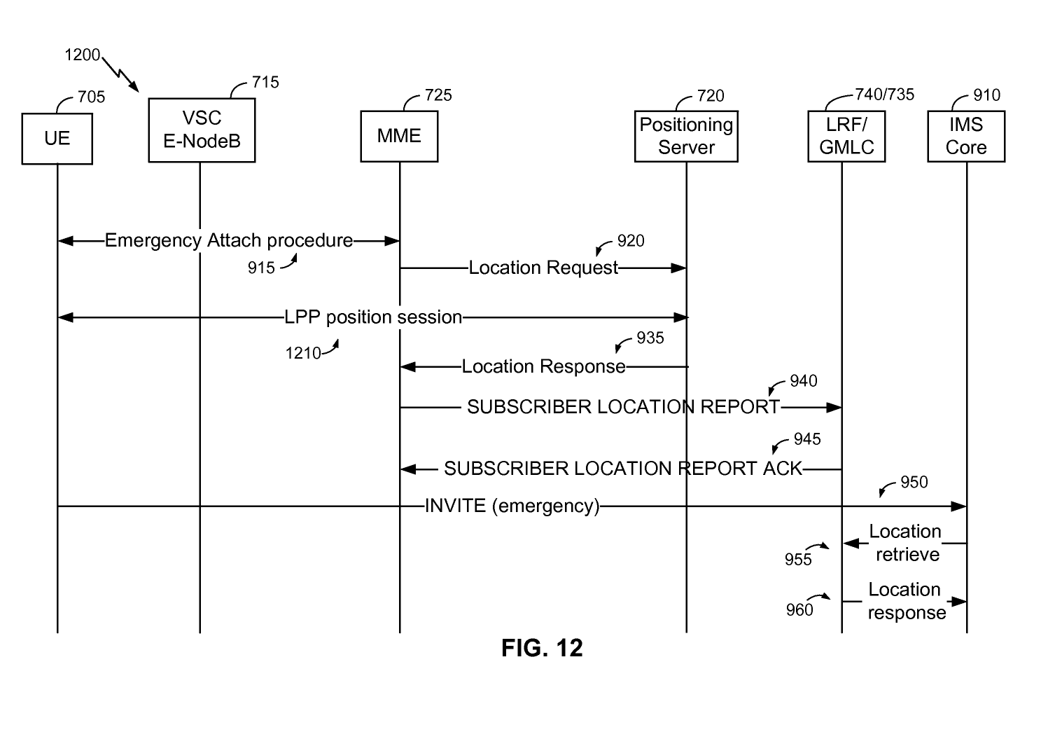

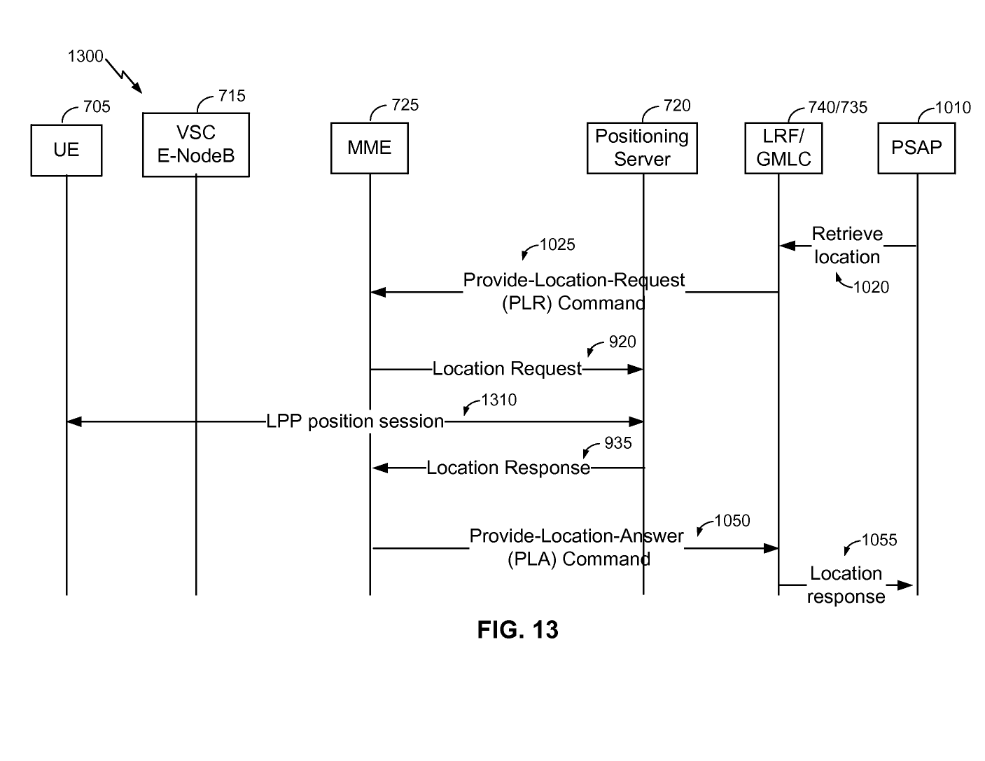

The flow charts 1200 and 1300 in FIGS. 12 and 13 respectively show the interaction among elements of system 1100 (FIG. 11) for UE location retrieval for the UE based location solution to support PSAP routing and by a call center (IMS emergency call is used as example and IMS core 910 represents the IMS elements selecting the PSAP). Thus, similarly to a VSC based location solution, flow-charts for PSAP routing and UE location are illustrated (FIGS. 12 and 13).

The UE based location solution for UE location retrieval differs from the VSC based location solution only in the procedures performed by positioning server 720 for UE location retrieval. In the VSC based location solution, the positioning server 720, upon establishing that the UE 705 is connected to a VSC, starts an LPPa protocol session to obtain UE location information from the VSC 710, as illustrated by steps 925 and 930 in FIG. 9. With the UE based location solution, the positioning server 720 starts an LPP position session directly with the UE 705 at step 1210. Step 1210 may comprise the exchange of one or more than one LPP message (e.g. as described in 3GPP TS 36.305) between UE 705 and positioning server 720 to enable positioning server 720 to obtain the location of UE 705 from UE 705 or obtain location measurements from UE 705 that positioning server 720 can use to determine the location of UE 705. The other steps in flow chart 1200 may be similar to or the same as like numbered steps in flow chart 900 and may be performed as described earlier in association with FIG. 9.

During the emergency session the destination PSAP may require an update of the UE location (e.g., to indicate to public safety responders the location of the user). UE location retrieval is performed through a Location retrieve/response message exchange at steps 1020 and 1055 with the LRF/GMLC 740/735 (see FIG. 10). If the UE location held by LRF/GMLC 740/735 is considered enough accurate (e.g. the UE location was recently retrieved), the LRF/GMLC 740/735 can immediately send the Location response with the UE location at step 1055. Alternatively, the LRF/GMLC 740/735 can poll, using steps 1025 and 1050, the MME 725 used by the UE 705 for an updated UE location. To obtain the UE location, the E-SMLC initiates a location request procedure directly with the UE 705 as illustrated in step 1310. Step 1310 may be similar to or the same as step 1210 in flow chart 1200. The other steps in flow chart 1300 may be similar to or the same as like numbered steps in flow chart 1200.

As the VSC based location solution using LPPa (e.g. as exemplified in FIGS. 9 and 10) relies on a position that may often be already available to the VSC 710, PSAP routing may be more efficiently and/or more quickly performed (e.g. according to flow chart 900) than with the UE based location solution (e.g., according to flow chart 1200). Similarly, any location provided to a PSAP may be more accurate and/or may be obtained more quickly using the VSC based location solution (e.g. according to flow chart 1000) than with the UE based location solution (e.g., according to flow chart 1300).

It should be noted that while many of the examples of the method described herein have assumed that a VSC (e.g. VSC 212 in FIGS. 2A-2C or VSC 710 FIGS. 7-13) supports LTE access by one or more UEs (e.g. UE 221 in FIGS. 2A-2C or UE 705 in FIGS. 7-13) and obtains a wireless backhaul connection from a serving network using LTE access, that other wireless technologies may be supported by a VSC to enable access by UEs and/or to obtain a wireless backhaul connection to a serving network. These technologies may include but are not limited to 3GPP W-CDMA, LTE-U (LTE in unlicensed spectrum), WiFi IEEE 802.11, IEEE 802.16, IEEE 802.20 and cdma2000. In addition, a VSC may support and/or use different wireless technologies to enable access by UEs as opposed to obtaining a wireless backhaul connection to a serving network. Further, in order to support a wireless backhaul connection to a serving network or home network, a VSC may access a satellite based communication system and not make use of access to terrestrial base stations.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect disclosed can include a computer readable media embodying a method for calibrating a small cell base station for management of a backhaul link to an ISP. Accordingly, the invention is not limited to illustrated examples and any means for performing the functionality described herein are included in aspects disclosed.

While the foregoing disclosure shows illustrative aspects disclosed, it should be noted that various changes and modifications could be made herein without departing from the scope of the invention as defined by the appended claims. The functions, steps and/or actions of the method claims in accordance with the aspects described herein need not be performed in any particular order. Furthermore, although elements disclosed may be described or claimed in the singular, the plural is contemplated unless limitation to the singular is explicitly stated.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of blocks or steps in the methods disclosed is an illustration of exemplary processes. Based upon design preferences, it is understood that the specific order or hierarchy of blocks or steps in the methods may be rearranged. The accompanying method claims present elements of the various blocks or steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), unless the element is expressly recited using the phrase “means for” or, in the case of a method claim, the element is recited using the phrase “step for.”

We claim:

1. A method at a small cell deployed in a vehicle for identifying the location of a wireless device, comprising:
enabling communication with a positioning server in a home network using a positioning protocol, wherein the communication is enabled using a wireless backhaul connection to a serving network;
receiving a location request from the positioning server for the location of the wireless device connected to the small cell and associated with an emergency call;
determining location information for the wireless device; and
providing, to the positioning server through the communication, the location information.

2. The method of claim 1, wherein the location information comprises location coordinates for the vehicle.

3. The method of claim 1, wherein the positioning server comprises an enhanced serving mobile location center (E-SMLC) and is selected by a mobility management entity (MME) in the home network.

4. The method of claim 1, wherein the positioning protocol comprises a Long Term Evolution (LTE) Positioning Protocol A (LPPa).

5. The method of claim 1, wherein the location request includes information indicating that the location request refers to the small cell.

6. The method of claim 5, wherein the wireless device is operated within the vehicle.

7. The method of claim 5, wherein the location request is sent by the positioning server in response to receiving a tracking area code or a cell identity assigned to the small cell when the small cell is initially registered in the home network, wherein the tracking area code or the cell identity indicate that the small cell is deployed in a vehicle.

8. The method of claim 2, further comprising:
receiving satellite positioning coordinates from a satellite navigation device communicatively coupled to the small cell, wherein the location coordinates of the vehicle comprise the satellite positioning coordinates.

9. The method of claim 1, further comprising:
requesting assistance data from a Secure User Plane Location (SUPL) Location Platform (SLP) in the home network;
receiving the assistance data; and
determining the location information based at least in part on the assistance data.

10. The method of claim 1, wherein enabling communication comprises establishing the wireless backhaul connection with the serving network based on a wireless local area network (WLAN) connection.

11. A computer-readable medium storing computer executable code for using a small cell deployed in a vehicle for identifying the location of a wireless device, comprising:
code for enabling communication with a positioning server in a home network using a positioning protocol, wherein the communication is enabled using a wireless backhaul connection to a serving network;
code for receiving a location request from the positioning server for the location of the wireless device connected to the small cell and associated with an emergency call;
code for determining location information for the wireless device; and
code for providing, to the positioning server through the communication, the location information.

12. The computer-readable medium of claim 11, wherein the positioning server comprises an enhanced serving mobile location center (E-SMLC) and is selected by a mobility management entity (MME) in the home network.

13. The computer-readable medium of claim 11, wherein the positioning protocol comprises a Long Term Evolution (LTE) Positioning Protocol A (LPPa).

14. The computer-readable medium of claim 11, wherein the code for enabling communication comprises code for enabling the wireless backhaul connection with the serving network based on a wireless local area network (WLAN) connection.

15. An apparatus at a small cell deployed in a vehicle for identifying the location of a wireless device, comprising:
means for enabling communication with a positioning server in a home network using a positioning protocol, wherein the communication is enabled using a wireless backhaul connection to a serving network;
means for receiving a location request from the positioning server for the location of the wireless device connected to the small cell and associated with an emergency call;
means for determining location information for the wireless device; and
means for providing, to the positioning server through the communication the location information.

16. The apparatus of claim 15, wherein the positioning server comprises an enhanced serving mobile location center (E-SMLC) and is selected by a mobility management entity (MME) in the home network.

17. The apparatus of claim 15, wherein the positioning protocol comprises a Long Term Evolution (LTE) Positioning Protocol A (LPPa).

18. The apparatus of claim 15, wherein the means for enabling communication comprises means for enabling the wireless backhaul connection with the serving network based on a wireless local area network (WLAN) connection.

19. An apparatus at a small cell deployed in a vehicle for identifying the location of a wireless device, comprising:
a communications component configured to enable communication with a positioning server in a home network using a positioning protocol, wherein the communication is enabled using a wireless backhaul connection to a serving network;
a receiver configured to receive a location request from the positioning server for the location of the wireless device connected to the small cell and associated with an emergency call; and
a location information component configured to determine location information for the wireless device,
wherein the communications component is further configured to provide, to the positioning server through the communication, the location information.

20. The apparatus of claim 19, wherein the location information comprises location coordinates for the vehicle.

21. The apparatus of claim 19, wherein the positioning server comprises an enhanced serving mobile location center (E-SMLC) and is selected by a mobility management entity (MME) in the home network.

22. The apparatus of claim 19, wherein the positioning protocol comprises a Long Term Evolution (LTE) Positioning Protocol A (LPPa).

23. The apparatus of claim 19, wherein the location request includes information indicating that the location request refers to a small cell.

24. The apparatus of claim 24, wherein the wireless device is operated within the vehicle.

25. The apparatus of claim 24, wherein the information in the location request indicates a tracking area code or a cell identity assigned to the small cell when deployed in the vehicle and when the small cell is initially registered in the home network.

26. The apparatus of claim 20, further comprising a satellite navigation device (SND) communications component configured to receive satellite positioning coordinates from a satellite navigation device communicatively coupled to the small cell, wherein the location coordinates of the vehicle comprises the satellite positioning coordinates.

27. The apparatus of claim 19, further comprising:
an assistance data component configured to request assistance data from a Secure User Plane Location (SUPL) Location Platform (SLP) in the home network and to receiving the assistance data, and
wherein the location information component is further configured to determine the location information based at least in part on the assistance data.

28. The apparatus of claim 19, wherein the communications component is further configured to enable the wireless backhaul connection to the serving network based on a wireless local area network (WLAN) connection.
